(19) United States
(12) Patent Application Publication
(10) Pub. No.: US 2026/0128225 A1
(43) Pub. Date: May 7, 2026

(54) MULTILAYER CERAMIC CAPACITOR

(71) Applicant: Murata Manufacturing Co., Ltd., Nagaokakyo-shi (JP)

(72) Inventor: Kosuke ONISHI, Nagaokakyo-shi (JP)

(21) Appl. No.: 19/437,423

(22) Filed: Dec. 31, 2025

Related U.S. Application Data
(63) Continuation of application No. PCT/JP2024/013804, filed on Apr. 3, 2024.

(30) Foreign Application Priority Data
Jul. 21, 2023 (JP) 2023-119007

(51) Int. Cl. H01G 4/30; H01G 4/012; H01G 4/232

(52) U.S. Cl. CPC H01G 4/30; H01G 4/012; H01G 4/232

(57) ABSTRACT

A multilayer ceramic capacitor includes a multilayer body including dielectric layers and inner electrode layers, first and second main surfaces facing each other in a lamination direction of the dielectric layers, first and second side surfaces facing each other in a width direction, and first and second end surfaces facing each other in a length direction, a first outer electrode on the first main surface and the first end surface of the multilayer body, and a second outer electrode on the first main surface and the second end surface of the multilayer body. The inner electrode layers are exposed from the first and second end surfaces, which are inclined so as to splay out from the first main surface toward the second main surface. Projecting portions including the dielectric layers and the inner electrode layers are located on the first and second end surfaces.

### CROSS REFERENCE TO RELATED APPLICATIONS

This application claims the benefit of priority to Japanese Patent Application No. 2023-119007 filed on Jul. 21, 2023 and is a Continuation Application of PCT Application No. PCT/JP2024/013804 filed on Apr. 3, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Electronic devices such as a mobile phone and a portable music player have recently become increasingly smaller and thinner. Accordingly, multilayer ceramic electronic components such as a multilayer ceramic capacitor installed in such a smaller and thinner electronic device have also become smaller and thinner. Particularly, multilayer ceramic electronic components that are becoming thinner are increasingly being used, for example, embedded in a wiring board, or being mounted in a very narrow space even when mounted on the surface of the wiring board. As such, the thinner the multilayer ceramic electronic components, the lower the mechanical strength thereof, leading to a strong demand for securing the mechanical strength.

For example, Japanese Unexamined Patent Application Publication No. 2012-4180 discloses a multilayer ceramic capacitor that has been made thinner. As a method for forming outer electrodes in the multilayer ceramic capacitor described in Japanese Unexamined Patent Application Publication No. 2012-4180, a conductive paste is applied by screen printing onto a ceramic mother block before division into chips for outer electrodes located on both main surfaces of a ceramic body (multilayer body), while the conductive paste is applied by immersing the end surfaces of the ceramic body in the conductive paste for outer electrodes located on both end surfaces of the ceramic body.

### SUMMARY OF THE INVENTION

In this case, the areas of inner electrode layers and ceramic layers exposed at both end surfaces of the multilayer body of the multilayer ceramic electronic component are small, which causes a problem in fixing strength between the outer electrodes and the multilayer body.

Example embodiments of the present invention provide multilayer ceramic capacitors each capable of improving fixing strength between a multilayer body and outer electrodes.

A multilayer ceramic capacitor according to an example embodiment of the present invention includes a multilayer body including a plurality of laminated dielectric layers, a plurality of inner electrode layers laminated on the dielectric layers, a first main surface and a second main surface facing each other in a lamination direction of the plurality of dielectric layers, a first side surface and a second side surface facing each other in a width direction orthogonal to the lamination direction, and a first end surface and a second end surface facing each other in a length direction orthogonal to the lamination direction and the width direction, a first outer electrode located on the first main surface and the first end surface of the multilayer body, and a second outer electrode located on the first main surface and the second end surface of the multilayer body, the inner electrode layers are exposed from the first end surface and the second end surface, the first end surface and the second end surface, from which the inner electrode layers are exposed, are inclined so as to splay out from the first main surface toward the second main surface, and first projecting portions including the dielectric layers and the inner electrode layers are provided on the first end surface and the second end surface.

In a multilayer ceramic capacitor according to an example embodiment of the present invention, the inner electrode layers are exposed from each of the first end surface and the second end surface. The first end surface and the second end surface from which the inner electrode layers are exposed are inclined so as to splay out from the first main surface toward the second main surface, and the first projecting portions including the dielectric layers and the inner electrode layers are provided on the first end surface and the second end surface. As the surface area of a metal component and a dielectric component in the first projecting portion increases, at least the contact area between a metal component in the outer electrode and a metal component in the multilayer body increases. As a result, the fixing strength between the multilayer body and the outer electrodes is improved.

Example embodiments of the present invention provide multilayer ceramic capacitors each capable of improving fixing strength between the multilayer body and the outer electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a multilayer ceramic capacitor according to a first example embodiment of the present invention.

FIG. 2 is a plan view illustrating an example of the multilayer ceramic capacitor according to the first example embodiment of the present invention.

FIG. 3 is a front view illustrating an example of the multilayer ceramic capacitor according to the first example embodiment of the present invention.

FIG. 4 is a side view illustrating an example of the multilayer ceramic capacitor according to the first example embodiment of the present invention.

FIG. 5 is a schematic sectional view taken along line V-V in FIG. 1.

FIG. 6 is a schematic sectional view taken along line VI-VI in FIG. 1.

FIG. 7 is a schematic sectional view taken along line VII-VII in FIG. 1.

FIG. 8A is an external perspective view of a multilayer body of the multilayer ceramic capacitor according to the first example embodiment of the present invention, and FIG. 8B is an external perspective view of the multilayer body as viewed from a different direction from FIG. 8A.

FIG. 9 is a schematic sectional view illustrating an example of a multilayer ceramic capacitor according to a first modification of the first example embodiment of the present invention.

FIG. 10 is a schematic sectional view illustrating an example of a multilayer ceramic capacitor according to a second modification of the first example embodiment of the present invention.

FIG. 11 is a schematic sectional view illustrating an example of a multilayer ceramic capacitor according to a third modification of the first example embodiment of the present invention.

FIG. 12 is a schematic sectional view illustrating an example of a multilayer ceramic capacitor according to a fourth modification of the first example embodiment of the present invention.

FIG. 13 is a schematic sectional view illustrating an example of a multilayer ceramic capacitor according to a fifth modification of the first example embodiment of the present invention.

FIG. 14 is an external perspective view illustrating an example of a multilayer ceramic capacitor according to a second example embodiment of the present invention.

FIG. 15 is an external perspective view illustrating an example of a multilayer ceramic capacitor according to a second example embodiment of the present invention.

FIG. 16 is a front view illustrating an example of the multilayer ceramic capacitor according to the second example embodiment of the present invention.

FIG. 17 is a side view illustrating an example of the multilayer ceramic capacitor according to the second example embodiment of the present invention.

FIG. 18 is a schematic sectional view taken along line XVIII-XVIII in FIG. 14.

FIG. 19 is a schematic sectional view taken along line XIX-XIX in FIG. 14.

FIG. 20 is a schematic sectional view taken along line XX-XX in FIG. 14.

FIG. 21 is a schematic sectional view taken along line XXI-XXI in FIG. 14.

FIG. 22A is an external perspective view of a multilayer body of the multilayer ceramic capacitor according to the second example embodiment of the present invention, and FIG. 22B is an external perspective view of the multilayer body as viewed from a different direction from FIG. 22A.

FIG. 23 is an external perspective view illustrating an example of a multilayer ceramic capacitor according to a third example embodiment of the present invention.

FIG. 24 is a schematic sectional view taken along line XXIV-XXIV in FIG. 23, illustrating a structure of an example of the multilayer ceramic capacitor according to the third example embodiment of the present invention.

FIG. 25 is a schematic sectional view taken along line XXV-XXV in FIG. 23, illustrating a structure of an example of the multilayer ceramic capacitor according to the third example embodiment of the present invention.

### DETAILED DESCRIPTION OF THE EXAMPLE EMBODIMENTS

Example embodiments of multilayer ceramic capacitors will be described below as examples of the present invention.

An example of a multilayer ceramic capacitor 10 according to an example embodiment of the present invention will be described.

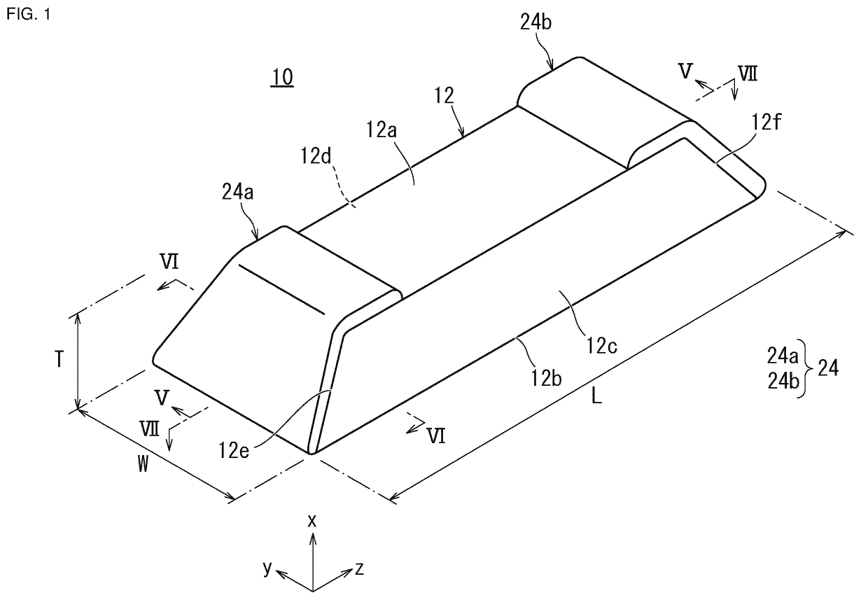

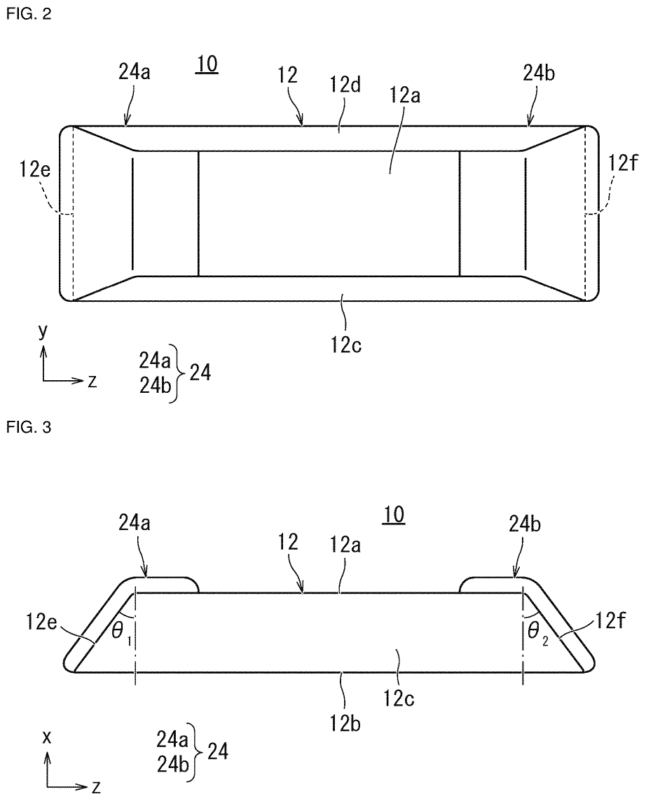

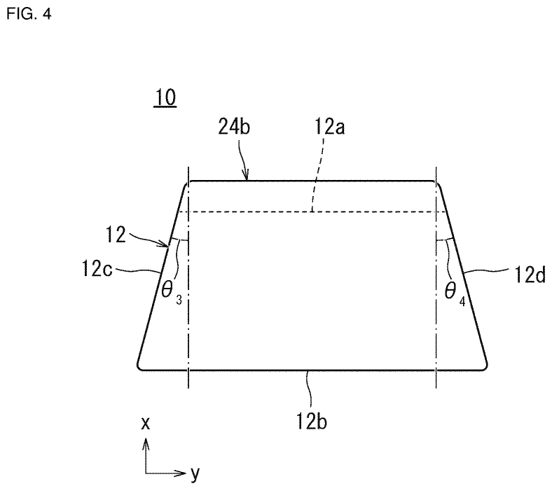

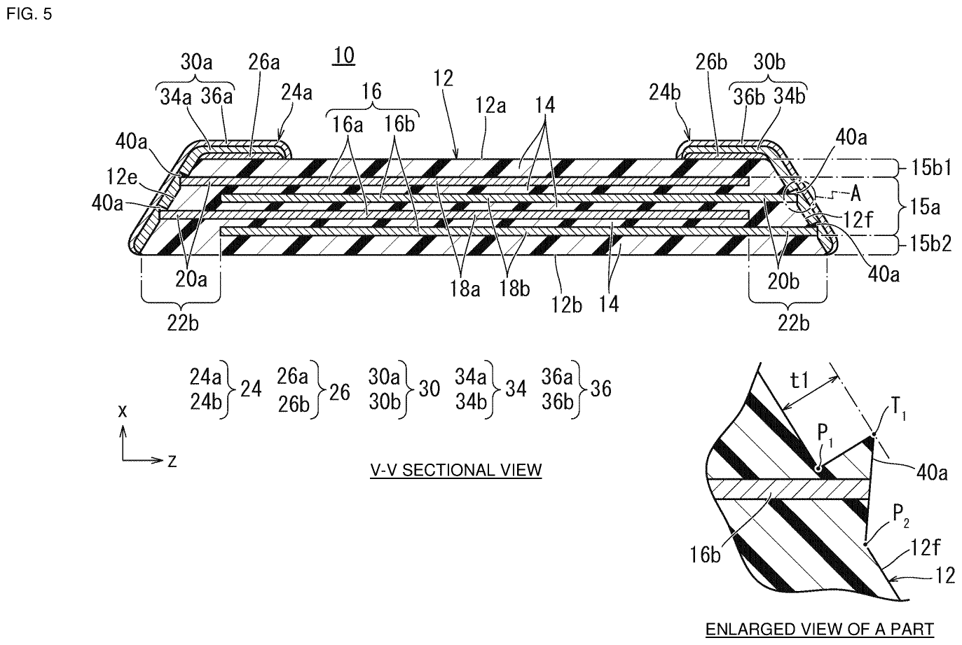

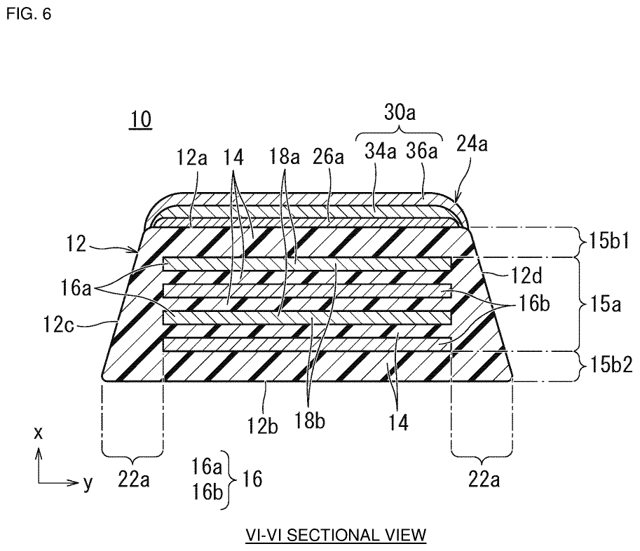

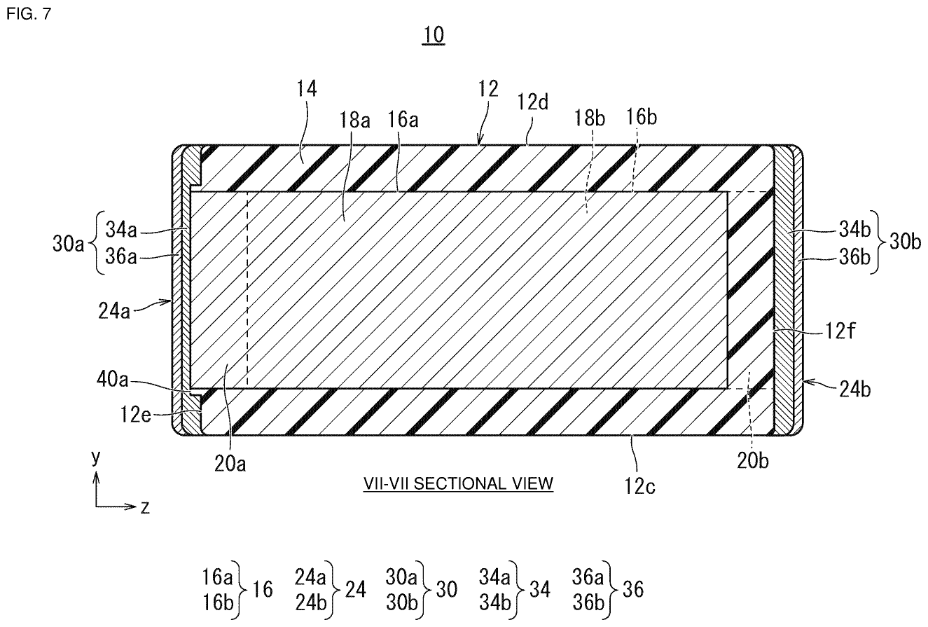

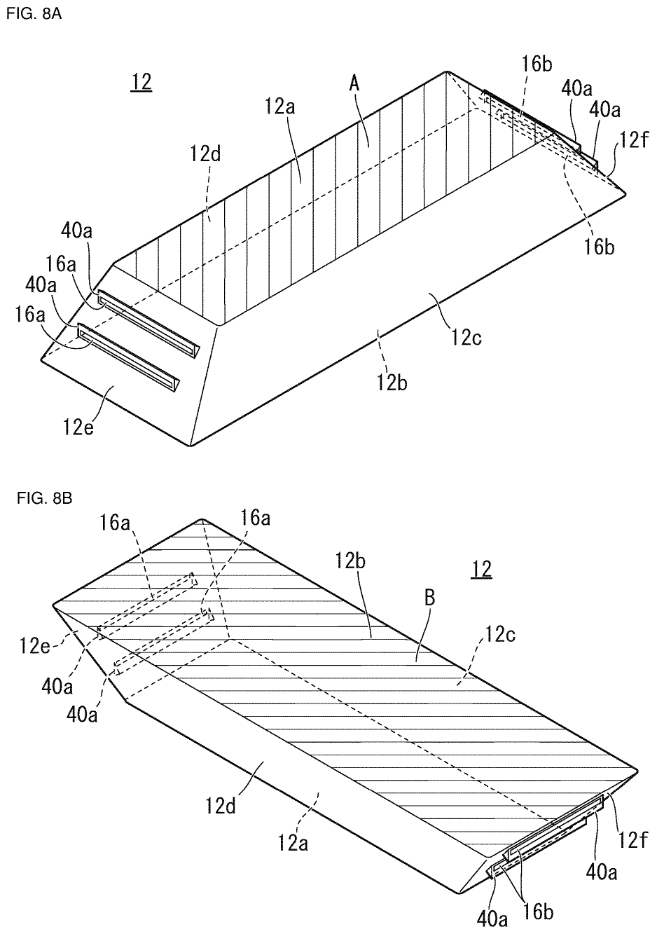

FIG. 1 is an external perspective view illustrating an example of a multilayer ceramic capacitor according to a first example embodiment of the present invention. FIG. 2 is a plan view illustrating an example of the multilayer ceramic capacitor according to the first example embodiment of the present invention. FIG. 3 is a front view illustrating an example of the multilayer ceramic capacitor according to the first example embodiment of the present invention. FIG. 4 is a side view illustrating an example of the multilayer ceramic capacitor according to the first example embodiment of the present invention. FIG. 5 is a schematic sectional view taken along line V-V in FIG. 1. FIG. 6 is a schematic sectional view taken along line VI-VI in FIG. 1. FIG. 7 is a schematic sectional view taken along line VII-VII in FIG. 1. FIG. 8A is an external perspective view of a multilayer body of the multilayer ceramic capacitor according to the first example embodiment of the present invention. FIG. 8B is an external perspective view of the multilayer body as viewed from a different direction from FIG. 8A.

The multilayer ceramic capacitor 10 includes a multilayer body 12 and an outer electrode 24. Hereinafter, configurations of the multilayer body 12 and the outer electrode 24 will be described in this order.

The multilayer body 12 includes a plurality of laminated dielectric layers 14 and a plurality of laminated inner electrode layers 16. The multilayer body 12 further includes a first main surface 12a and a second main surface 12b facing each other in a height direction x that is the lamination direction of the plurality of dielectric layers 14, a first side surface 12c and a second side surface 12d facing each other in a width direction y orthogonal to the height direction x, and a first end surface 12e and a second end surface 12f facing each other in a length direction z orthogonal to the height direction x and the width direction y.

The multilayer body 12 has rounded corner and ridge portions. The corner portion refers to the intersection of three adjacent surfaces of the multilayer body 12. The ridge portion refers to the intersection of two adjacent surfaces of the multilayer body 12. Furthermore, unevenness or the like may be present on a portion or an entirety of the first main surface 12a and the second main surface 12b, the first side surface 12c and the second side surface 12d, and the first end surface 12e and the second end surface 12f.

It is preferable that the first main surface 12a and/or the second main surface 12b be flat. A flat surface allows the stress received from a nozzle for picking up the multilayer ceramic capacitor 10 to be dispersed across the flat surface, thus improving the strength of the multilayer ceramic capacitor 10 upon mounting. The multilayer ceramic capacitor 10 according to this example embodiment includes the second main surface 12b that is flat.

As illustrated in FIGS. 5 and 6, the multilayer body 12 includes, in the height direction x connecting the first main surface 12a to the second main surface 12b: an inner layer portion 15a in which a plurality of inner electrode layers 16 face each other, a first main surface-side outer layer portion 15b1 including a plurality of dielectric layers 14 located between the first main surface 12a and the inner electrode layer 16 located closest to the first main surface 12a, and a second main surface-side outer layer portion 15b2 including a plurality of dielectric layers 14 located between the second main surface 12b and the inner electrode layer 16 located closest to the second main surface 12b.

The first main surface-side outer layer portion 15b1 and the second main surface-side outer layer portion 15b2 may become integrated after baking and cannot be distinguishable from one another, but are an aggregate of a plurality of outer dielectric layers.

The first main surface-side outer layer portion 15b1 is located on the first main surface 12a side of the multilayer body 12 and is an aggregate of a plurality of dielectric layers 14 located between the first main surface 12a and the inner electrode layer 16 closest to the first main surface 12a.

The second main surface-side outer layer portion 15b2 is located on the second main surface 12b side of the multilayer body 12 and is an aggregate of a plurality of dielectric layers 14 located between the second main surface 12b and the inner electrode layer 16 closest to the second main surface 12b.

The dimensions of the multilayer body 12 are not particularly limited, but it is preferable that the dimension in the length direction z be about 0.1 mm to about 1.6 mm, inclusive, the dimension in the width direction y be about 0.1 mm to about 1.6 mm, inclusive, and the dimension in the height direction x be about 0.01 mm to about 0.1 mm, inclusive, for example.

The dielectric layer 14 can include a dielectric material, for example. The dielectric material can have a plurality of crystal grains including a perovskite compound with a basic structure of BaTiO₃, for example. As a specific material of the dielectric layer 14, dielectric ceramics composed mainly of CaTiO₃, SrTiO₃, CaZrO₃ or the like, besides BaTiO₃, can be used. Depending on the desired characteristics of the multilayer body, it is also possible to use a material including a smaller amount of subcomponent than the main component such as Mn compound, Fe compound, Cr compound, Co compound, or Ni compound.

The outer dielectric layer can include a plurality of crystal grains including a perovskite compound with a basic structure of BaTiO₃, for example. For example, dielectric ceramics composed mainly of BaTiO₃, CaTiO₃, SrTiO₃, CaZrO₃ or the like can be used. Alternatively, subcomponents such as Mn compound, Fe compound, Cr compound, Co compound, or Ni compound may also be added to these main components. The materials of the dielectric layer 14 and the outer dielectric layer may be different depending on the desired functions. For example, a soft outer dielectric layer can buffer stress on the multilayer body, while a hard outer dielectric layer can reduce or prevent the occurrence of cracks.

The inner layer portion 15a is the region sandwiched between the first main surface-side outer layer portion 15b1 and the second main surface-side outer layer portion 15b2.

As illustrated in FIGS. 8A and 8B, the condition A<B is satisfied in the lamination direction of the multilayer body 12, where A is the area of the first main surface 12a and B is the area of the second main surface 12b.

The first end surface 12e and the second end surface 12f are inclined so as to splay out from the first main surface 12a toward the second main surface 12b. The first side surface 12c and the second side surface 12d may also be inclined so as to splay out from the first main surface 12a toward the second main surface 12b.

It is preferable that about 5°≤θ₁≤about 50° and about 5°≤θ₂≤about 50°, for example, be satisfied, where θ₁ is the angle between the first end surface 12e and a perpendicular line drawn to an extension of the side of the first main surface 12a at the intersection of the first main surface 12a and the first end surface 12e of the multilayer body 12, and θ₂ is the angle between the second end surface 12f and a perpendicular line drawn to the extension of the side of the first main surface 12a at the intersection of the first main surface 12a and the second end surface 12f of the multilayer body 12.

It is preferable that about 5°≤θ₃≤about 50° and about 5°≤θ₄≤about 50°, for example, be satisfied, where θ₃ is the angle between the first side surface 12c and a perpendicular line drawn to the extension of the side of the first main surface 12a at the intersection of the first main surface 12a and the first side surface 12c of the multilayer body 12, and θ₄ is the angle between the second side surface 12d and a perpendicular line drawn to the extension of the side of the first main surface 12a at the intersection of the first main surface 12a and the second side surface 12d of the multilayer body 12.

The number of dielectric layers 14 to be laminated is not particularly limited, but is preferably 3 to 700, inclusive, in total, including the inner layer portion 15a, the first main surface-side outer layer portion 15b1, and the second main surface-side outer layer portion 15b2. Furthermore, the inner layer portion 15a preferably has a thickness of about 0.4 μm to about 2.0 μm, inclusive, for example. The first main surface-side outer layer portion 15b1 and the second main surface-side outer layer portion 15b2 each preferably have a thickness of about 2.0 μm to about 10.0 μm, inclusive, for example.

As illustrated in FIGS. 5 and 6, the inner electrode layer 16 includes first inner electrode layers 16a and second inner electrode layers 16b. The first inner electrode layers 16a and the second inner electrode layers 16b are alternately laminated with the dielectric layers 14 interposed therebetween.

The first inner electrode layer 16a is located on the surface of the dielectric layer 14. The first inner electrode layer 16a includes a first counter electrode portion 18a facing the second inner electrode layer 16b, and a first extended electrode portion 20a located on one end side of the first inner electrode layer 16a and extended from the first counter electrode portion 18a to the first end surface 12e of the multilayer body 12. The first extended electrode portion 20a has its end portion extended and exposed to the first end surface 12e.

The shape of the first counter electrode portion 18a of the first inner electrode layer 16a is not particularly limited, but is preferably rectangular or substantially rectangular in plan view. However, the corners in plan view may be rounded or the corners may be angled in plan view (tapered shape). Alternatively, the shape may be a tapered shape in plan view that is inclined in either direction.

The shape of the first extended electrode portion 20a of the first inner electrode layer 16a is not particularly limited, but is preferably rectangular or substantially rectangular in plan view. However, the corners in plan view may be rounded or the corners may be angled in plan view (tapered shape). Alternatively, the shape may be a tapered shape in plan view that is inclined in either direction.

The width of the first counter electrode portion 18a of the first inner electrode layer 16a may be the same as the width of the first extended electrode portion 20a of the first inner electrode layer 16a, or one of the widths may be narrower.

The second inner electrode layer 16b is located on the surface of the dielectric layer 14 different from the dielectric layer 14 on which the first inner electrode layer 16a is located. The second inner electrode layer 16b includes a second counter electrode portion 18b facing the first inner electrode layer 16a, and a second extended electrode portion 20b located on one end side of the second inner electrode layer 16b and extended from the second counter electrode portion 18b to the second end surface 12f of the multilayer body 12. The second extended electrode portion 20b has its end portion extended and exposed to the second end surface 12f.

The shape of the second counter electrode portion 18b of the second inner electrode layer 16b is not particularly limited, but is preferably rectangular or substantially rectangular in plan view. However, the corners in plan view may be rounded or the corners may be angled in plan view (tapered shape). Alternatively, the shape may be a tapered shape in plan view that is inclined in either direction.

The shape of the second extended electrode portion 20b of the second inner electrode layer 16b is not particularly limited, but is preferably rectangular or substantially rectangular in plan view. However, the corners in plan view may be rounded or the corners may be angled in plan view (tapered shape). Alternatively, the shape may be a tapered shape in plan view that is inclined in either direction.

The width of the second counter electrode portion 18b of the second inner electrode layer 16b may be the same as the width of the second extended electrode portion 20b of the second inner electrode layer 16b, or one of the widths may be narrower.

The first extended electrode portion 20a of the first inner electrode layer 16a and the second extended electrode portion 20b of the second inner electrode layer 16b may be curved toward the first main surface 12a or the second main surface 12b. Furthermore, the longest distance in the height direction x between the exposed portions of the first extended electrode portion 20a of the first inner electrode layer 16a extended to the first end surface 12e and the longest distance in the height direction x between the exposed portions of the second extended electrode portion 20b of the second inner electrode layer 16b extended to the second end surface 12f may be shorter than the longest distance in the height direction x between the first counter electrode portion 18a of the first inner electrode layer 16a and the second counter electrode portion 18b of the second inner electrode layer 16b.

The number of inner electrode layers 16 to be laminated is not particularly limited, but is preferably 2 to 700, inclusive. The inner electrode layer 16 preferably has a thickness of 0.2 μm to 2.0 μm, inclusive.

The multilayer body 12 includes side portions 22a (W gaps) of the multilayer body 12 located between the inner electrode layer 16 and the first side surface 12c and between the inner electrode layer 16 and the second side surface 12d. Furthermore, the multilayer body 12 includes end portions 22b (L gaps) of the multilayer body 12 located between the inner electrode layer 16 and the first end surface 12e and between the inner electrode layer 16 and the second end surface 12f.

The inner electrode layers 16 can be made of, but not limited to, an appropriate conductive material, such as metals such as Ni, Cu, Ag, Pd, and Au, or alloys including at least one of these metals, such as Ag—Pd alloy.

Sn included in the first inner electrode layer 16a and the second inner electrode layer 16b can alleviate the electric field concentration at the interface between the inner electrode layer 16 and the dielectric layer 14, leading to improved high-temperature load reliability. In this case, Sn can be sufficiently effective even if it is included in only one of the first inner electrode layer 16a and the second inner electrode layer 16b.

In this example embodiment, the first counter electrode portion 18a of the first inner electrode layer 16a and the second counter electrode portion 18b of the second inner electrode layer 16b face each other with the dielectric layer 14 interposed therebetween, thus generating an electrostatic capacitance and exhibiting capacitor characteristics.

In order to increase the capacitance of the capacitor, the area of the inner electrode layer 16 needs to be increased. Therefore, the inner electrode layer 16 preferably has a LW surface coverage of more than or equal to about 90%, for example. The LW surface coverage is defined as the percentage of the area inside the edge portion of the inner electrode layer 16 as viewed from the LW surface of the multilayer body 12 minus the area of any voids. The higher the LW surface coverage, the higher the capacitance of the capacitor. However, even with a lower LW surface coverage, the dielectric layers 14 are bonded with voids interposed therebetween, thus increasing the bonding strength between the layers to reduce or prevent interlayer peeling.

The inner layer portion 15a includes first projecting portions 40a located on the first end surface 12e and the second end surface 12f. If the inner electrode layer 16 is extended and exposed at the first side surface 12c and the second side surface 12d, the inner layer portion 15a preferably includes second projecting portions.

The first projecting portions 40a include the inner electrode layer 16 and the dielectric layer 14. More specifically, the first projecting portion 40a located on the first end surface 12e is including the first inner electrode layer 16a and the dielectric layer 14 exposed from the first end surface 12e. Similarly, the first projecting portion 40a located on the second end surface 12f is including the second inner electrode layer 16b and the dielectric layer 14 exposed from the second end surface 12f. This increases the surface area of the metal component and the dielectric component of the first projecting portions 40a, thus increasing at least the contact area between the metal component in the outer electrode 24 and the metal component of the multilayer body 12. As a result, the fixing strength between the multilayer body 12 and the outer electrode 24 is improved.

In this case, at least two or more first projecting portions 40a are provided. Five or more first projecting portions 40a are more preferable to increase the contact area between the multilayer body 12 and the outer electrode 24.

It is preferable that, in the width direction y, the angle T₁P₁P₂≥the angle T₁P₂P₁ be satisfied, where the vertex T₁ of the first projecting portion is the portion having the greatest thickness in the direction perpendicular to the end surface, P₁ is the end point of the first projecting portion 40a on the first main surface 12a side, and P₂ is the end point of the first projecting portion 40a on the second main surface 12b side, as illustrated in FIG. 5. Furthermore, it is preferable that the angle T₁P₁P₂ and the angle T₁P₂P₁ be about 15° to about 75°, inclusive, for example. This makes it possible to reduce the stress applied to the first projecting portion 40a.

The thickness of the first projecting portion 40a is the thickness in the direction perpendicular to the first end surface 12e. That is, the thickness t1 of the first projecting portion 40a is the shortest distance between the vertex T₁ of the first projecting portion 40a and the first end surface 12e of the multilayer body 12. The thickness t1 of the first projecting portion 40a is preferably about 0.3 μm to about 3.0 μm, inclusive, for example. If the thickness t1 of the first projecting portion 40a is less than about 0.3 μm, for example, the end surface is too smooth, making it difficult to sufficiently improve the fixing strength between the multilayer body 12 and the outer electrode 24.

As illustrated in FIGS. 1 to 7, the outer electrode 24 is located on the first end surface 12e and the second end surface 12f of the multilayer body 12.

The outer electrode 24 includes a thin film layer 26 and a plating layer 30 covering the thin film layer 26.

The outer electrode 24 includes a first outer electrode 24a and a second outer electrode 24b.

The first outer electrode 24a is located on the first end surface 12e and a portion of the first main surface 12a of the multilayer body 12. In this case, the first outer electrode 24a is electrically connected to the first extended electrode portion 20a of the first inner electrode layer 16a. The first outer electrode 24a may extend slightly onto the second main surface 12b, a portion of the first side surface 12c, and a portion of the second side surface 12d.

The second outer electrode 24b is located on the second end surface 12f and a portion of the first main surface 12a of the multilayer body 12. In this case, the second outer electrode 24b is electrically connected to the second extended electrode portion 20b of the second inner electrode layer 16b. The second outer electrode 24b may extend slightly onto the second main surface 12b, a portion of the first side surface 12c, and a portion of the second side surface 12d.

The outer electrode 24 is including the thin film layer 26, an upper plating layer 34 covering the thin film layer 26, and a surface plating layer 36 covering the upper plating layer 34.

The thin film layer 26 includes a first thin film layer 26a and a second thin film layer 26b.

The first thin film layer 26a covers a portion of the first main surface 12a on the first end surface 12e side of the multilayer body 12, but does not cover the first end surface 12e of the multilayer body 12. The first thin film layer 26a may also extend around to one of the surfaces in contact with the first main surface 12a.

The second thin film layer 26b covers a portion of the first main surface 12a on the second end surface 12f side of the multilayer body 12, but does not cover the second end surface 12f of the multilayer body 12. The second thin film layer 26b may also extend around to one of the surfaces in contact with the first main surface 12a.

The first thin film layer 26a and the second thin film layer 26b are preferably formed by deposition of metal particles using a method such as sputtering or vapor deposition. Accordingly, the thickness of the first thin film layer 26a and the second thin film layer 26b in the direction connecting the first main surface 12a and the second main surface 12b of the multilayer body 12 can be less than or equal to about 1μm, allowing the dimension in the height direction x of the multilayer ceramic capacitor 10 to be sufficiently small for height reduction.

The dimension in the height direction x of the first thin film layer 26a and the second thin film layer 26b can be measured as follows. Specifically, in a case of forming the thin film layers by depositing metal particles, a fluorescent X-ray apparatus can be used to obtain the thickness converted from the concentration of a specified element using the calibration curve method for the relevant metal species. Alternatively, an FIB cross-section of the component can be observed with a scanning microscope to measure the thickness from an actual observation image.

In a case of forming the first thin film layer 26a and the second thin film layer 26b by a thin film formation method, these thin film layers can be including metals such as Cu, Cr, Au, Pt, Ag, Sn, Ti, or Ni.

The first thin film layer 26a and the second thin film layer 26b can be formed taking into consideration their respective functions. For example, in consideration of adhesion with the multilayer body 12, NiCr or NiCu is preferably used as the main component. Alternatively, the first thin film layer 26a and the second thin film layer 26b may be including a plurality of layers, or may have a two-layer structure of NiCr and NiCu.

The thin film layer 26 may be formed by screen printing, CVD, ALD, or the like, and include a dielectric material and a metal component. These methods can further improve the fixing strength between the multilayer body and the outer electrode by fixing the thin film layer 26 and the ceramic of the multilayer body 12. In this case, the thin film layer 26 may have a discontinuous shape. The term “discontinuous” means that the thin film layer is formed discontinuously as viewed from a direction perpendicular to the longitudinal direction.

For example, in a case of forming the thin film layer 26 from a ceramic-including material, one method is to polish the cross-section and then take a sectional image using a digital microscope (Keyence Corporation: VHX-5000) to calculate the thickness from the sectional image. Another method is to measure the thickness or other parameters from an FIB sectional image of the component actually observed with a scanning microscope.

In a case where the first thin film layer 26a and the second thin film layer 26b each include the same main component as the dielectric layer 14, the adhesion can be further improved by simultaneously firing the multilayer body 12 with the first thin film layer 26a and the second thin film layer 26b. In this case, the metal component is preferably Ni, Cu, or the like, but can be changed as appropriate depending on the metal component of the inner electrode layer 16.

The plating layer 30 includes a first plating layer 30a and a second plating layer 30b.

The first plating layer 30a covers the first thin film layer 26a and the first end surface 12e of the multilayer body 12.

The second plating layer 30b covers the second thin film layer 26b and the second end surface 12f of the multilayer body 12.

The plating layer 30 includes a plurality of layers. Specifically, the plating layer 30 includes an upper plating layer 34 and a surface plating layer 36.

The upper plating layer 34 includes a first upper plating layer 34a included in the first plating layer 30a and a second upper plating layer 34b included in the second plating layer 30b. The surface plating layer 36 includes a first surface plating layer 36a included in the first plating layer 30a and a second surface plating layer 36b included in the second plating layer 30b.

The first upper plating layer 34a of the upper plating layer 34 covers a first direct plating layer 28a of a direct plating layer 28 and the first thin film layer 26a.

The second upper plating layer 34b of the upper plating layer 34 covers a second direct plating layer 28b of the direct plating layer 28 and the second thin film layer 26b.

The upper plating layer 34 is preferably Ni plating to reduce solder corrosion.

The first surface plating layer 36a of the surface plating layer 36 covers the first upper plating layer 34a of the upper plating layer 34.

The second surface plating layer 36b of the surface plating layer 36 covers the second upper plating layer 34b of the upper plating layer 34.

The surface plating layer 36 is preferably Sn plating with good bonding strength with solder used for mounting of the multilayer ceramic capacitor 10. The surface plating layer 36 may also be Cu plating. In this case, the bonding strength with vias formed when the multilayer ceramic capacitor 10 is embedded in a mounting substrate is improved.

The plating layer 30 may also be including the surface plating layer 36 alone. In this case, the first surface plating layer 36a of the surface plating layer 36 covers the first thin film layer 26a, and the second surface plating layer 36b of the surface plating layer 36 covers the second thin film layer 26b.

The metal content per unit volume of the plating layer 30 is preferably more than or equal to about 99 volume %, for example.

The thickness per layer of the plating layer 30 is preferably about 1.0 μm to about 10.0 μm, inclusive, for example.

The shape of the outer electrode 24 may follow the outer shape of the multilayer body 12. In other words, when the first projecting portion 40a is formed, the outer electrode 24 may also have an uneven shape, as with the shapes of the first end surface 12e and the second end surface 12f of the multilayer body 12.

It is assumed that the dimension in the length direction z of the multilayer ceramic capacitor 10, including the multilayer body 12, the first outer electrode 24a, and the second outer electrode 24b, is the L dimension, the dimension in the height direction x of the multilayer ceramic capacitor 10, including the multilayer body 12, the first outer electrode 24a, and the second outer electrode 24b, is the T dimension, and the dimension in the width direction y of the multilayer ceramic capacitor 10, including the multilayer body 12, the first outer electrode 24a, and the second outer electrode 24b, is the W dimension.

It is preferable that the dimensions of the multilayer ceramic capacitor 10 be such that the L dimension in the length direction z is about 0.1 mm to about 1.6 mm, inclusive, the T dimension in the height direction x is about 10 μm to about 100 μm, inclusive, and the W dimension in the width direction y is about 0.1 mm to about 1.6 mm, inclusive, for example. In the multilayer ceramic capacitor 10 illustrated in FIG. 1, the L dimension is greater than the W dimension.

In this example embodiment, the effects of the present invention can be effectively achieved when the T dimension in the height direction x of the multilayer ceramic capacitor 10 is less than or equal to about 100 μm, and are even more effective when the T dimension in the height direction x of the multilayer ceramic capacitor 10 is less than or equal to about 55 μm, or less than or equal to about 50 μm, for example.

In the multilayer ceramic capacitor 10 according to the first example embodiment illustrated in FIG. 1, the first end surface 12e and the second end surface 12f are inclined so as to splay out from the first main surface 12a toward the second main surface 12b. The first inner electrode layer 16a is exposed from the first end surface 12e, the second inner electrode layer 16b is exposed from the second end surface 12f, and the first projecting portions 40a are provided on the first end surface 12e and the second end surface 12f. The first projecting portions 40a include the inner electrode layer 16 and the dielectric layer 14, thus increasing the surface area of the metal component and the dielectric component. This increases at least the contact area between the metal component in the outer electrode 24 and the metal component of the multilayer body 12. As a result, the fixing strength between the multilayer body 12 and the outer electrode 24 is improved.

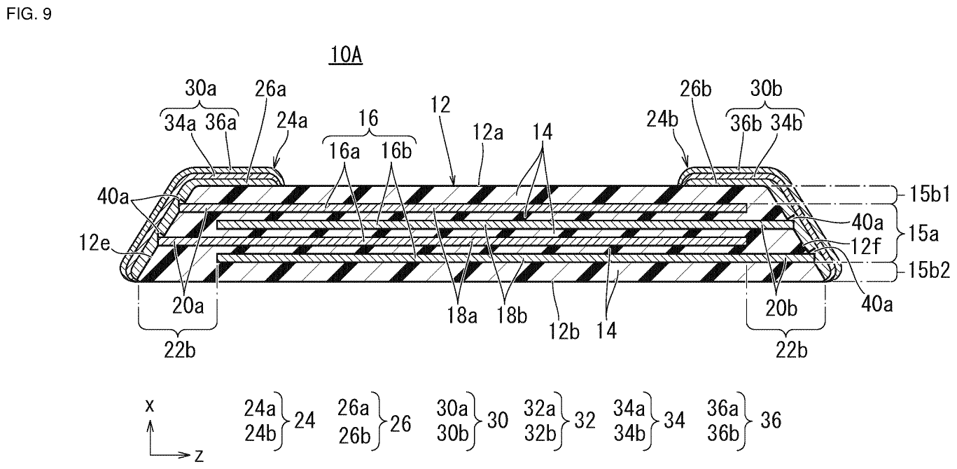

Next, an example of a multilayer ceramic capacitor 10A according to a first modification of the first example embodiment of the present invention will be described. FIG. 9 is a schematic sectional view illustrating an example of the multilayer ceramic capacitor according to the first modification of the first example embodiment of the present invention. Note, however, that components identical or corresponding to those in FIGS. 1 to 8 will be denoted by the same reference numerals, and detailed description thereof will be omitted.

In the multilayer ceramic capacitor 10A according to the first modification, as illustrated in FIG. 9, a first thin film layer 26a and a second thin film layer 26b are each wrapping around to a first end surface 12e and a second end surface 12f of the multilayer body 12.

Specifically, the first thin film layer 26a wraps around and cover the first end surface 12e from the first main surface 12a. The second thin film layer 26b also wraps around and cover the second end surface 12f from the first main surface 12a.

The first thin film layer 26a is directly electrically connected to a first extended electrode portion 20a of a first inner electrode layer 16a exposed from the first end surface 12e. The second thin film layer 26b is directly electrically connected to a second extended electrode portion 20b of a second inner electrode layer 16b exposed from the second end surface 12f.

The first thin film layer 26a may be configured so that a thin film layer on the first main surface 12a and a thin film layer on the first end surface 12e are continuously connected, or may be discontinuous at a ridge portion. Similarly, the second thin film layer 26b may be configured so that a thin film layer on the first main surface 12a and a thin film layer on the second end surface 12f are continuously connected, or may be discontinuous at a ridge portion.

The multilayer ceramic capacitor 10A according to the first example embodiment illustrated in FIG. 9 achieves the same effects as the multilayer ceramic capacitor 10 described above, as well as the following effect.

Since the first thin film layer 26a is provided on the first end surface 12e and the second thin film layer 26b is provided on the second end surface 12f, the first projecting portion 40a increases the contact area between the metal component in the multilayer body 12 and the metal component in the thin film layer 26, and also increases the contact area between the dielectric component in the multilayer body 12 and the dielectric component in the thin film layer 26. As a result, the fixing strength between the multilayer body 12 and the outer electrode 24 is further improved.

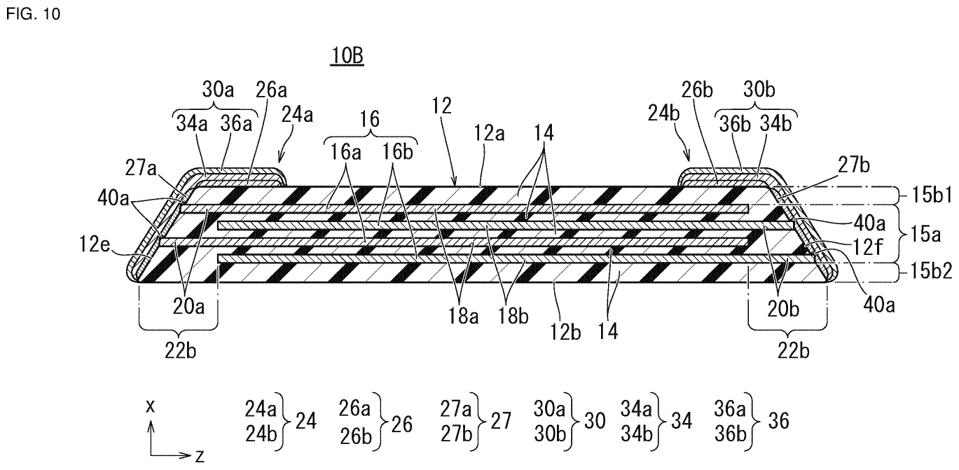

Next, an example of a multilayer ceramic capacitor 10B according to the second modification of the first example embodiment of the present invention will be described. FIG. 10 is a schematic sectional view illustrating an example of the multilayer ceramic capacitor according to the second modification of the first example embodiment of the present invention. Note, however, that components identical or corresponding to those in FIGS. 1 to 8 will be denoted by the same reference numerals, and detailed description thereof will be omitted.

As illustrated in FIG. 10, an underlying electrode layer 27 is provided on both end surfaces 12e and 12f of the multilayer ceramic capacitor 10B according to the second modification of the first example embodiment.

The underlying electrode layer 27 includes a first underlying electrode layer 27a and a second underlying electrode layer 27b.

The first underlying electrode layer 27a covers the first end surface 12e of the multilayer body 12. The first underlying electrode layer 27a is electrically connected directly to the first extended electrode portion 20a of the first inner electrode layer 16a.

The first underlying electrode layer 27a may have its upper end overlapping the lower side of the first thin film layer 26a on the ridge portion defined by the first main surface 12a and the first end surface 12e of the multilayer body 12.

The second underlying electrode layer 27b covers the second end surface 12f of the multilayer body 12. The second underlying electrode layer 27b is electrically connected directly to the second extended electrode portion 20b of the second inner electrode layer 16b.

The second underlying electrode layer 27b may have its upper end overlapping the lower side of the second thin film layer 26b on the ridge portion defined by the first main surface 12a and the second end surface 12f of the multilayer body 12.

Note that the first thin film layer 26a may be partially provided to wrap around to the first end surface 12e, and the second thin film layer 26b may be partially provided to wrap around to the second end surface 12f.

The underlying electrode layer 27 includes a baked layer, for example.

In this case, the baked layer includes a metal component and a glass component. The glass component of the baked layer includes at least one selected from B, Si, Ba, Mg, Al, Li, and the like. The metal component of the baked layer includes, for example, at least one selected from Cu, Ni, Ag, Pd, Ag—Pd alloy, Au, and the like. The baked layer is formed by applying a conductive paste including glass and metal to the multilayer body and baking the conductive paste. The baked layer is formed by co-firing a multilayer chip having the inner electrode layer 16 and the dielectric layer 14 with a conductive paste applied to the multilayer chip. Alternatively, the baked layer may be formed by firing the multilayer chip having the inner electrode layer 16 and the dielectric layer 14, followed by baking. The baked layer may be including a plurality of layers.

The thickness per layer of the underlying electrode layer 27 is preferably about 0.1 μm to about 200 μm, inclusive, for example.

The first underlying electrode layer 27a and the second underlying electrode layer 27b may have their upper ends spaced apart from the first thin film layer 26a and the second thin film layer 26b, respectively.

The multilayer ceramic capacitor 10B according to the first example embodiment illustrated in FIG. 10 achieves the same effects as the multilayer ceramic capacitor 10 described above, as well as the following effect.

Since the first underlying electrode layer 27a is provided on the first end surface 12e and the second underlying electrode layer 27b is provided on the second end surface 12f, the first projecting portion 40a increases the surface area of the metal component and the dielectric component. This increases the contact area between the metal component in the multilayer body 12 and the metal component of the underlying electrode layer 27, and also increases the contact area between the dielectric component in the multilayer body 12 and the glass component in the underlying electrode layer 27. As a result, the fixing strength between the multilayer body 12 and the outer electrode 24 can be further improved.

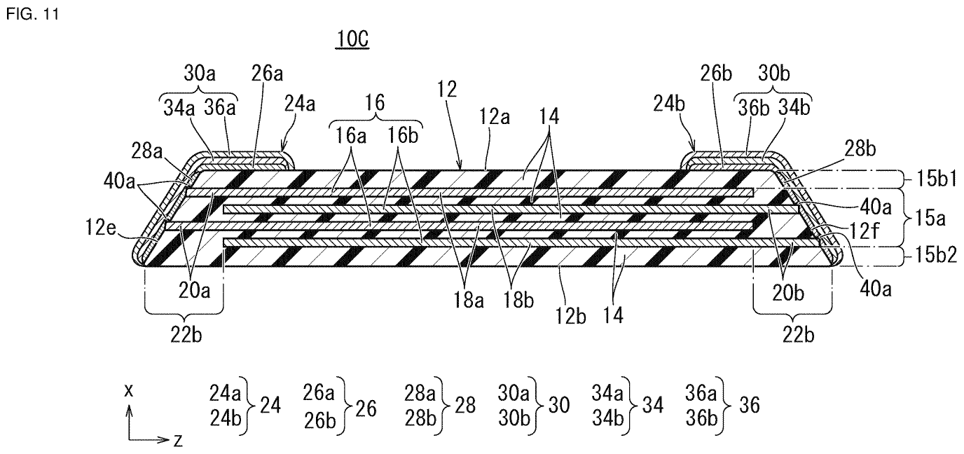

Next, an example of a multilayer ceramic capacitor 10C according to a third modification of the first example embodiment of the present invention will be described. FIG. 11 is a schematic sectional view illustrating an example of the multilayer ceramic capacitor according to the third modification of the first example embodiment of the present invention. Note, however, that components identical or corresponding to those in FIGS. 1 to 8 will be denoted by the same reference numerals, and detailed description thereof will be omitted.

As illustrated in FIG. 11, a direct plating layer 28 is provided on both end surfaces 12e and 12f of the multilayer ceramic capacitor 10C according to the third modification of the first example embodiment.

The direct plating layer 28 includes a first direct plating layer 28a and a second direct plating layer 28b.

The first direct plating layer 28a covers the first end surface 12e of the multilayer body 12. The first direct plating layer 28a is electrically connected directly to the first extended electrode portion 20a of the first inner electrode layer 16a.

The first direct plating layer 28a has its upper end overlapping the lower side of the first thin film layer 26a on the ridge portion defined by the first main surface 12a and the first end surface 12e of the multilayer body 12.

The second direct plating layer 28b covers the second end surface 12f of the multilayer body 12. The second direct plating layer 28b is electrically connected directly to the second extended electrode portion 20b of the second inner electrode layer 16b.

The second direct plating layer 28b has its upper end overlapping the lower side of the second thin film layer 26b on the ridge portion defined by the first main surface 12a and the second end surface 12f of the multilayer body 12.

Note that the first direct plating layer 28a may be partially provided to wrap around to the second main surface 12b, and the second direct plating layer 28b may be partially provided to wrap around to the second main surface 12b.

The direct plating layer 28 is not particularly limited as long as at least one metal selected from the group consisting of Cu, Ni, Ag, Pd, Ag—Pd alloy, Au, and the like, for example, is included as its main metal component. For example, if the first inner electrode layer 16a and the second inner electrode layer 16b are formed using Ni, Cu plating having good bondability with Ni is preferably used for the direct plating layer 28.

The direct plating layer 28 is formed by plating growing from the inner electrode layer 16, so as to cover the first end surface 12e and the second end surface 12f.

The thickness per layer of the direct plating layer 28 is preferably about 2.0 μm to about 10.0 μm, inclusive, for example.

The first direct plating layer 28a and the second direct plating layer 28b may have their upper ends spaced apart from the first thin film layer 26a and the second thin film layer 26b, respectively.

Accordingly, the thickness of the outer electrode 24 on the first main surface 12a in the lamination direction can be further reduced, thus making it possible to provide a multilayer ceramic capacitor with further reduced height without impairing mountability upon mounting.

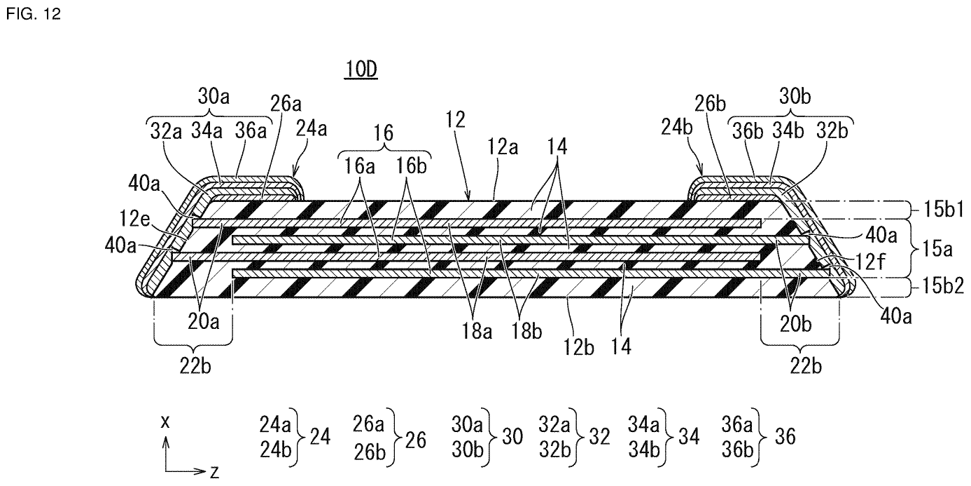

Next, an example of a multilayer ceramic capacitor 10D according to a fourth modification of the first example embodiment of the present invention will be described. FIG. 12 is a schematic sectional view illustrating an example of the multilayer ceramic capacitor according to the fourth modification of the first example embodiment of the present invention. Note, however, that components identical or corresponding to those in FIGS. 1 to 8 will be denoted by the same reference numerals, and detailed description thereof will be omitted.

As illustrated in FIG. 12, in the multilayer ceramic capacitor 10D according to the fourth modification, the plating layer 30 of the outer electrode 24 further includes a lower plating layer 32 between the thin film layer 26 and the upper plating layer 34. As a result, the upper plating layer 34 of the plating layer 30 indirectly covers the thin film layer 26 with the lower plating layer 32 interposed therebetween.

With such a configuration, the lower plating layer 32 can block moisture from entering the multilayer ceramic capacitor 10D from the outside.

The multilayer ceramic capacitor 10D according to the fourth modification illustrated in FIG. 12 achieves the same effects as the multilayer ceramic capacitor 10 illustrated in FIG. 1. The multilayer ceramic capacitor 10D according to the fourth modification can also reduce or prevent moisture intrusion from the outside.

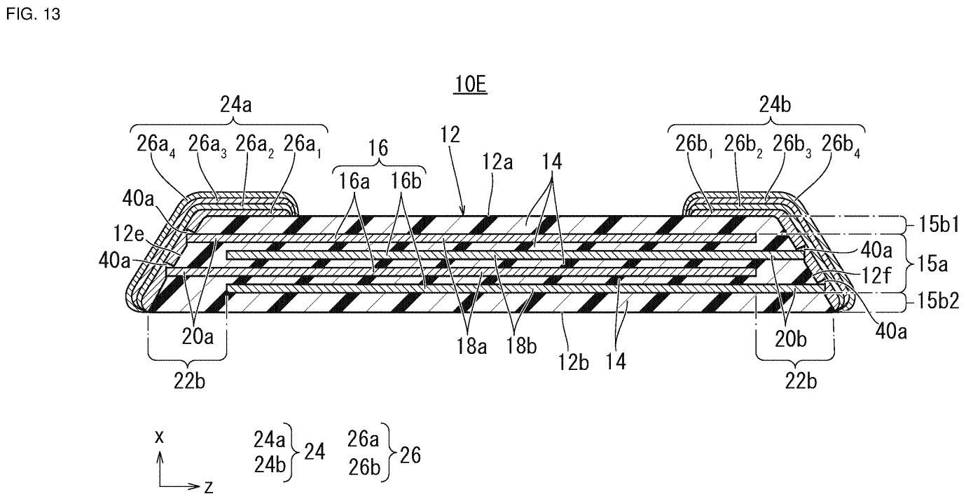

Next, a multilayer ceramic capacitor 10E according to a fifth modification of the first example embodiment of the present invention will be described. FIG. 13 is a schematic sectional view illustrating an example of the multilayer ceramic capacitor according to the fifth modification of the first example embodiment of the present invention. Note, however, that components identical or corresponding to those in FIGS. 1 to 8 will be denoted by the same reference numerals, and detailed description thereof will be omitted.

The outer electrode 24 of the multilayer ceramic capacitor 10E according to the fifth modification includes no plating layers, and is including a plurality of thin film layers. In the multilayer ceramic capacitor 10E illustrated in FIG. 13, for example, the first outer electrode 24a includes no plating layers and is composed only of four thin film layers 26a1 to 26a4, while the second outer electrode 24b includes no plating layers and only includes four thin film layers 26b1 to 26b4.

In the first outer electrode 24a, the thin film layer 26a1 wraps around and cover the first end surface 12e from the first main surface 12a. The thin film layers 26a2, 26a3, and 26a4 are arranged in this order on the surface of the thin film layer 26a1.

In the second outer electrode 24b, the thin film layer 26b1 wraps around and cover the second end surface 12f from the first main surface 12a. The thin film layers 26b2, 26b3, and 26b4 are arranged in this order on the surface of the thin film layer 26b1.

In the first outer electrode 24a, respective edge portions of the four thin film layers 26a1 to 26a4 near the center of the multilayer body 12 may be or do not have to cover the corresponding edge portions of the respective lower layers. Similarly, in the second outer electrode 24b, respective edge portions of the four thin film layers 26b1 to 26b4 near the center of the multilayer body 12 may be or do not have to cover the corresponding edge portions of the respective lower layers.

The multilayer ceramic capacitor 10E according to the first example embodiment illustrated in FIG. 13 achieves the same effects as the multilayer ceramic capacitor 10 described above, as well as the following effect.

Specifically, the multilayer ceramic capacitor 10E includes no plating layers. The first outer electrode 24a only includes the thin film layers 26a1 to 26a4, and the second outer electrode 24b only includes the thin film layers 26b1 to 26b4. This makes it possible to reduce the T dimension in the height direction x and the L dimension in the length direction z, thus reducing the dimensions of the multilayer ceramic capacitor.

A non-limiting example of a method for manufacturing a multilayer ceramic capacitor as an example of the multilayer ceramic capacitor according to the first example embodiment will be described below.

First, a dielectric sheet and a conductive paste for inner electrodes are prepared. The dielectric sheet and the conductive paste for inner electrode layers contain a binder (for example, a known organic binder) and an organic solvent (for example, a known organic solvent).

Next, the conductive paste for inner electrodes is applied in a predetermined pattern onto the dielectric sheet by screen printing, gravure printing or the like, for example, to form an inner electrode pattern. As for the dielectric sheet, a dielectric sheet for outer layers without any inner electrode pattern printed thereon is also prepared.

A predetermined number of such dielectric sheets for outer layers without any inner electrode pattern formed thereon are laminated, and then the dielectric sheet with the inner electrode pattern formed thereon, corresponding to the first inner electrode layer 16a, and the dielectric sheet with the inner electrode pattern formed thereon, corresponding to the second inner electrode layer 16b are alternately laminated thereon. Finally, a predetermined number of dielectric sheets for outer layers without any inner electrode pattern formed thereon are further laminated thereon to form a multilayer sheet.

Furthermore, the multilayer sheet is pressed in the lamination direction by an isostatic press or the like to form a multilayer block.

Next, the multilayer block is cut to a specified size to cut out multilayer chips. Thereafter, wet barreling may be performed to round the corners and ridge portions of the multilayer chip.

The multilayer chip is formed into a tapered shape. Upon cutting the multilayer block into chips, a dicer cut is made using a tapered blade to form an angled end surface shape. The taper angle is between about 10° and about 80°, inclusive, for example, with a non-tapered blade having the taper angle of 0°, for example. Since the taper angle of the blade taper does not necessarily correspond to the angle of the end surface of the cut chip, the taper angle is finely adjusted to the desired angle.

Accordingly, both side surfaces and both end surfaces are inclined so as to splay out from the first main surface side toward the second main surface side. As a result, the inner electrode pattern exposed from both end surfaces can be confirmed as seen from the first main surface side.

Next, the multilayer chip is fired to produce the multilayer body 12. The firing temperature depends on the ceramic and the material of the inner electrode layer 16, but is preferably between about 900° C. and about 1400° C., inclusive, for example.

Next, the fired multilayer chips are aligned on an adhesive tape with the first main surface side facing upward. For example, if the first main surface side faces upward, the inner electrode layer 16 can be confirmed from both end surfaces, allowing for appearance selection and alignment.

The chips are then sandblasted with an abrasive and polished at an angle perpendicular to the first main surface. During this process, the outer layer portions near the first main surface on both end surfaces are easily scraped. On the other hand, the outer layer portions near the second main surface on both end surfaces are not easily scraped because the inner electrode layers 16 exposed from the end surfaces form an umbrella. Furthermore, cutting debris from the sandblasting process is easily accumulated to reduce or prevent the scraping. Since the likelihood of scraping differs between the first main surface-side outer layer portion and the second main surface-side outer layer portion, the projecting portion can be formed on the end surface. Examples of the abrasive to be used include alumina oxide abrasive, zirconia alumina abrasive, silicon carbide abrasive, and the like.

Next, after sandblasting, any cutting debris adhering to the multilayer chips is removed. Such cutting debris can be removed, for example, by blowing air onto the chips.

Then, the multilayer chips with the projecting portions are removed from the adhesive tape. In this event, with the use of a foam release sheet as the adhesive tape, for example, a plurality of multilayer chips can be removed all at once by applying heat.

Thereafter, the multilayer body 12 with the first projecting portion 40a formed thereon is aligned on a workbench, and a first thin film layer 26a and a second thin film layer 26b are formed on the first main surface 12a by sputtering or vapor deposition.

Next, a first upper plating layer 34a covers the first thin film layer 26a on a portion of the first main surface 12a of the multilayer body 12, and a first surface plating layer 36a covers the first upper plating layer 34a. Similarly, a second upper plating layer 34b covers the second thin film layer 26b on a portion of the first main surface 12a of the multilayer body 12, and a second surface plating layer 36b covers the second upper plating layer 34b. Specifically, the upper plating layer 34 is Ni plating, and the surface plating layer 36 is Sn plating, which are formed by electrolytic plating or electroless plating.

In a case of forming an underlying electrode layer 27, a prepared conductive paste to be the underlying electrode layer is applied to both end surfaces of the multilayer body, forming the underlying electrode layer. The conductive paste can be applied to both end surfaces of the multilayer body by dipping, screen printing or the like. The baking temperature is preferably about 700° C. to about 900° C., inclusive.

In a case of forming a direct plating layer 28, it is formed as follows.

Specifically, a first direct plating layer 28a and a second direct plating layer 28b are formed on the first end surface 12e and the second end surface 12f of the multilayer body 12, respectively. The multilayer body 12 with the direct plating layer 28 formed thereon is then heat-treated to remove residual moisture remaining in the plating film and at the interface between the multilayer body 12 and the direct plating layer 28. Thereafter, the multilayer body 12 with the direct plating layer 28 formed thereon is aligned on the workbench, and a thin film layer 26 is formed on the first main surface 12a by sputtering or vapor deposition. In a case of forming the direct plating layer 28 on the thin film layer 26, the thin film layer 26 is formed by sputtering or vapor deposition, and then the direct plating layer 28 is formed.

Next, the first upper plating layer 34a covers the first thin film layer 26a on a portion of the first main surface 12a of the multilayer body 12 and the first direct plating layer 28a on the first end surface 12e of the multilayer body 12. Similarly, the second upper plating layer 34b covers the second thin film layer 26b on a portion of the first main surface 12a of the multilayer body 12 and the second direct plating layer 28b on the second end surface 12f of the multilayer body 12. The upper plating layer 34 is Ni plating, which is formed by electrolytic plating or electroless plating.

Then, the first surface plating layer 36a covers the first upper plating layer 34a. Similarly, the second surface plating layer 36b covers the second upper plating layer 34b. The surface plating layer 36 is Sn plating, which is formed by electrolytic plating or electroless plating.

The multilayer ceramic capacitor 10 according to the first example embodiment illustrated in FIG. 1 is thus manufactured.

The method for manufacturing a multilayer ceramic capacitor according to this example embodiment can provide a multilayer ceramic capacitor with improved fixing strength between the multilayer body 12 and the outer electrode 24.

Next, an example of a multilayer ceramic capacitor 510 according to a second example embodiment of the present invention will be described.

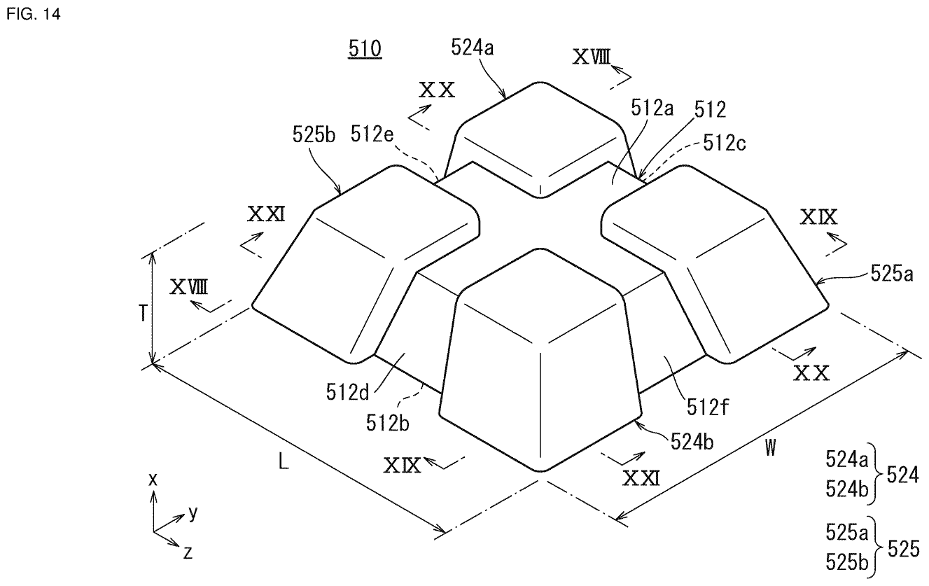

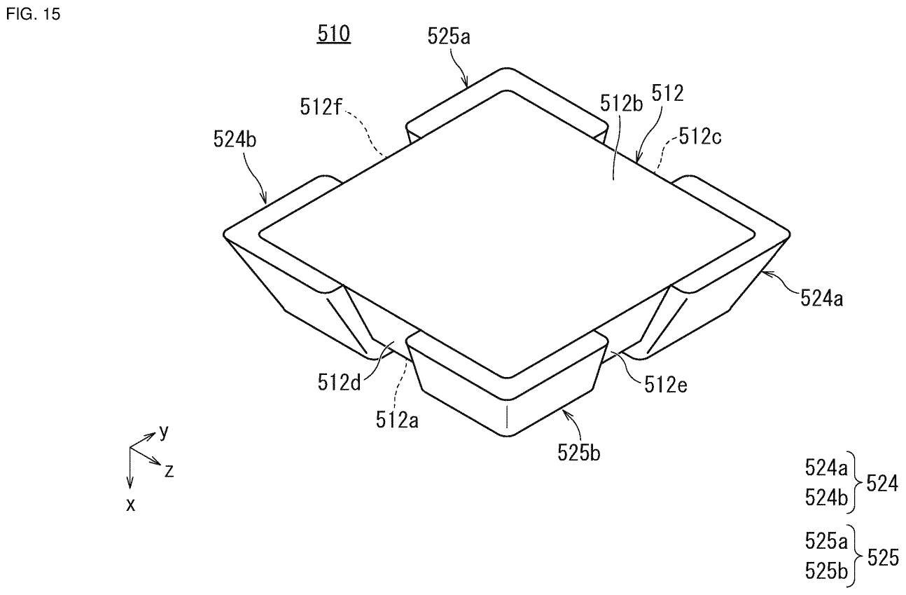

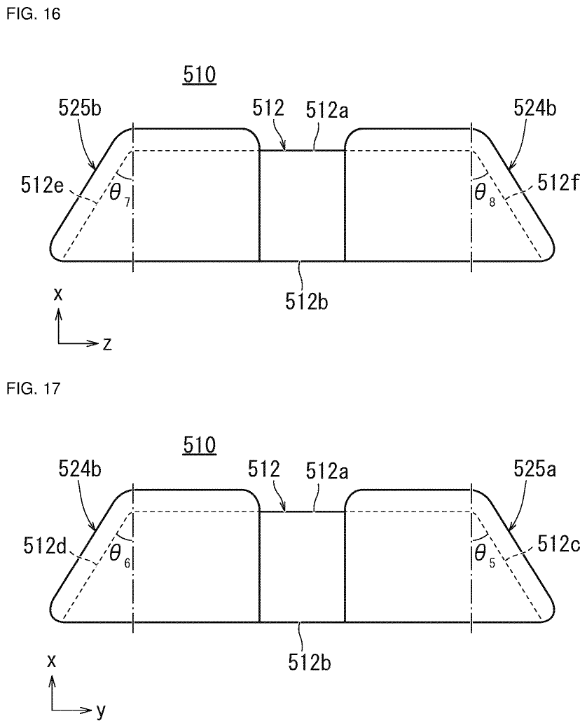

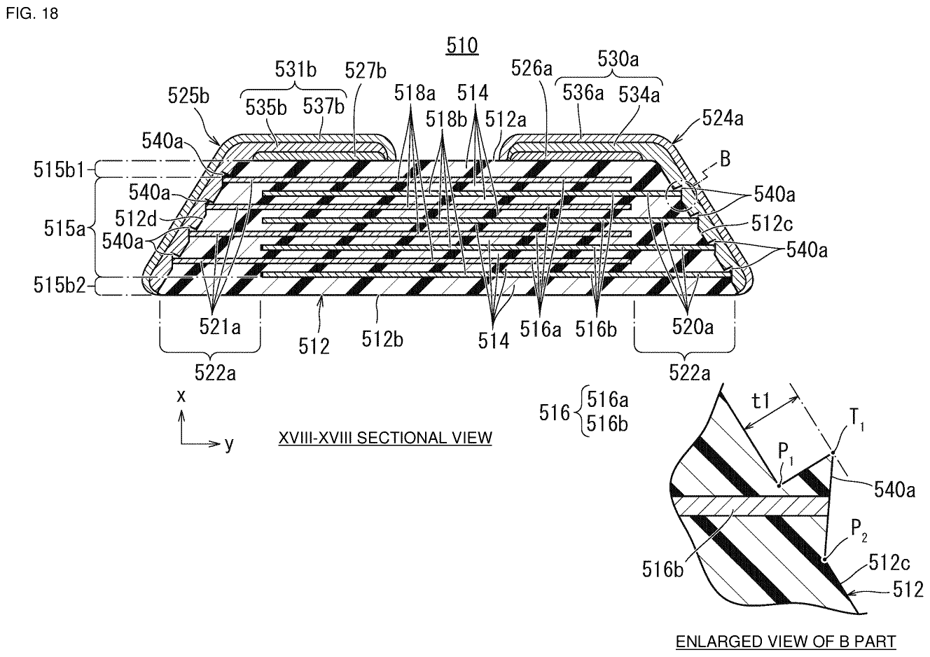

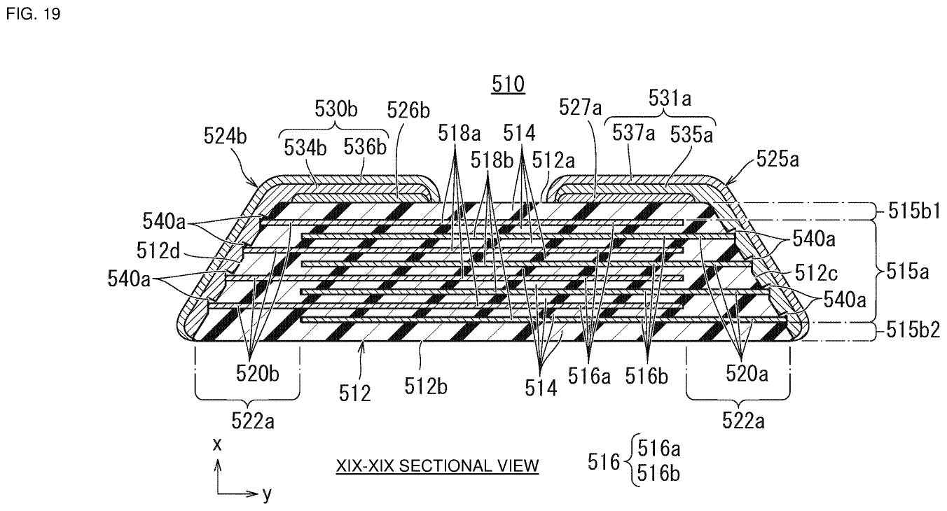

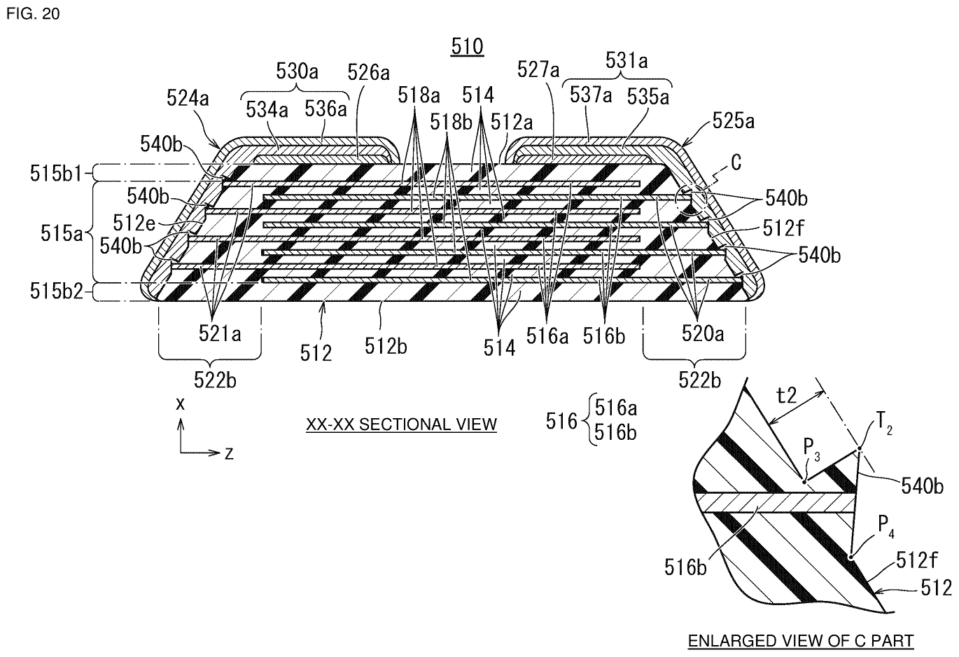

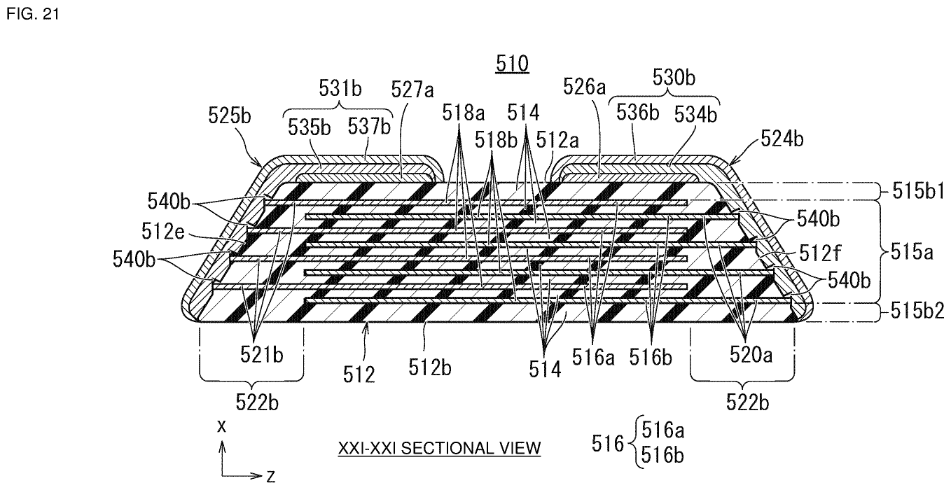

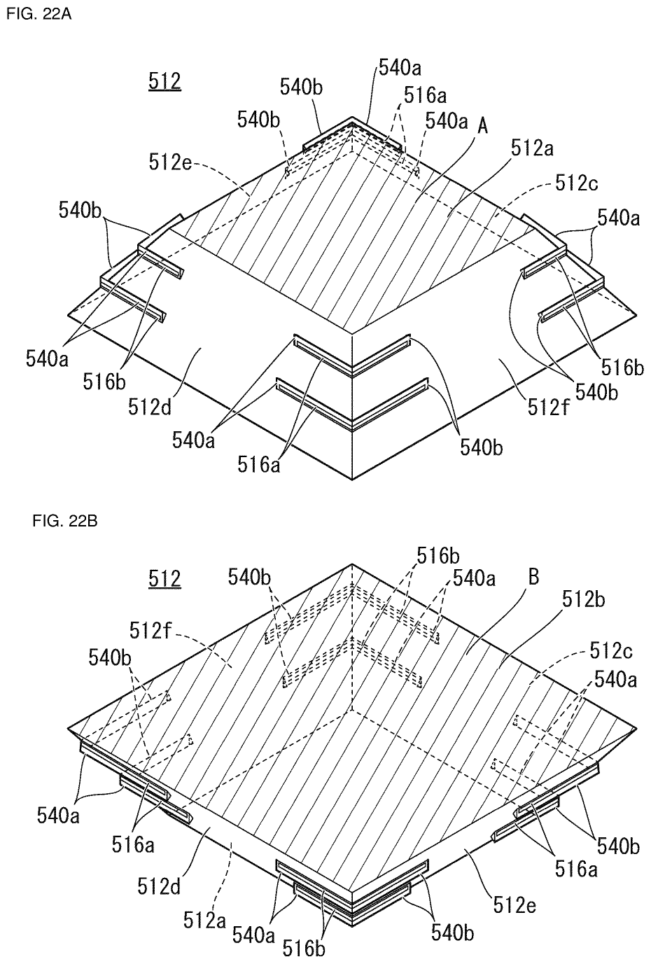

FIG. 14 is an external perspective view illustrating an example of the multilayer ceramic capacitor according to the second example embodiment of the present invention. FIG. 15 is an external perspective view illustrating an example of the multilayer ceramic capacitor according to the second example embodiment of the present invention. FIG. 16 is a front view illustrating an example of the multilayer ceramic capacitor according to the second example embodiment of the present invention. FIG. 17 is a side view illustrating an example of the multilayer ceramic capacitor according to the second example embodiment of the present invention. FIG. 18 is a schematic sectional view taken along line XVIII-XVIII in FIG. 14. FIG. 19 is a schematic sectional view taken along line XIX-XIX in FIG. 14. FIG. 20 is a schematic sectional view taken along line XX-XX in FIG. 14. FIG. 21 is a schematic sectional view taken along line XXI-XXI in FIG. 14. FIG. 22A is an external perspective view of a multilayer body of the multilayer ceramic capacitor according to the second example embodiment of the present invention. FIG. 22B is an external perspective view of the multilayer body as viewed from a different direction from FIG. 22A.

The multilayer ceramic capacitor 510 includes a multilayer body 512 and outer electrodes 524 and 525.

The multilayer body 512 includes a plurality of dielectric layers 514 and a plurality of inner electrode layers 516. The multilayer body 512 includes a first main surface 512a and a second main surface 512b facing each other in a height direction x, a first side surface 512c and a second side surface 512d facing each other in a width direction y orthogonal to the height direction x, and a third side surface 512e and a fourth side surface 512f facing each other in a length direction z orthogonal to the height direction x and the width direction y. The first main surface 512a and the second main surface 512b extend along the width direction y and the length direction z. The first side surface 512c and the second side surface 512d extend along the height direction x and the length direction z. The third side surface 512e and the fourth side surface 512f extend along the height direction x and the width direction y. Therefore, the height direction x is the direction connecting the first main surface 512a and the second main surface 512b. The width direction y is the direction connecting the first side surface 512c and the second side surface 512d. The length direction z is the direction connecting the third side surface 512e and the fourth side surface 512f.

The multilayer body 512 preferably includes rounded corner and ridge portions. The corner portion refers to the intersection of three adjacent surfaces of the multilayer body 512. The ridge portion refers to the intersection of two adjacent surfaces of the multilayer body 512.

It is preferable that the first main surface 512a and/or the second main surface 512b be flat. A flat surface allows the stress received from a nozzle for picking up the multilayer ceramic capacitor 510 to be dispersed across the flat surface, thus improving the strength of the multilayer ceramic capacitor 510 upon mounting. The multilayer ceramic capacitor 510 according to this example embodiment has the second main surface 512b that is flat.

As illustrated in FIGS. 18 to 21, the multilayer body 512 includes, in the height direction x connecting the first main surface 512a to the second main surface 512b, an inner layer portion 515a in which a plurality of inner electrode layers 516 face each other, a first main surface-side outer layer portion 515b1 formed of a plurality of dielectric layers 514 located between the first main surface 512a and the inner electrode layer 516 located closest to the first main surface 512a, and a second main surface-side outer layer portion 515b2 including a plurality of dielectric layers 514 located between the second main surface 512b and the inner electrode layer 516 located closest to the second main surface 512b.

The first main surface-side outer layer portion 515b1 and the second main surface-side outer layer portion 515b2 may become integrated after baking and cannot be distinguishable from one another, but are an aggregate of a plurality of outer dielectric layers.

The first main surface-side outer layer portion 515b1 is located on the first main surface 512a side of the multilayer body 512, and is an aggregate of a plurality of dielectric layers 514 located between the first main surface 512a and the inner electrode layer 516 closest to the first main surface 512a.

The second main surface-side outer layer portion 515b2 is located on the second main surface 512b side of the multilayer body 512, and is an aggregate of a plurality of dielectric layers 514 located between the second main surface 512b and the inner electrode layer 516 closest to the second main surface 512b.

The dielectric layer 514 can be formed of a dielectric material, for example. As the dielectric material, dielectric ceramics including mainly, for example, BaTiO₃, CaTiO₃, SrTiO₃, or CaZrO₃ can be used. Depending on the desired characteristics of the multilayer body, it is also possible to use a material including a smaller amount of subcomponent than the main component such as Mn compound, Fe compound, Cr compound, Co compound, or Ni compound.

The outer dielectric layer can include a plurality of crystal grains including a perovskite compound with a basic structure of BaTiO₃, for example. For example, dielectric ceramics composed mainly of BaTiO₃, CaTiO₃, SrTiO₃, CaZrO₃ or the like can be used. Alternatively, subcomponents such as Mn compound, Fe compound, Cr compound, Co compound, or Ni compound may also be added to these main components. The materials of the dielectric layer 514 and the outer dielectric layer may be different depending on the desired functions. For example, a soft outer dielectric layer can buffer stress on the multilayer body, while a hard outer dielectric layer can reduce or prevent the occurrence of cracks.

The inner layer portion 515a is the region sandwiched between the first main surface-side outer layer portion 515b1 and the second main surface-side outer layer portion 515b2.

As illustrated in FIGS. 22A and 22B, the condition A<B is satisfied in the lamination direction of the multilayer body 512, where A is the area of the first main surface 512a and B is the area of the second main surface 512b.

The first side surface 512c and the second side surface 512d are inclined so as to splay out from the first main surface 512a toward the second main surface 512b. The third side surface 512e and the fourth side surface 512f are also inclined so as to splay out from the first main surface 512a toward the second main surface 512b.

It is preferable that about 5°≤θ₅≤about 50° and about 5°≤θ₆≤about 50°, for example, be satisfied, where θ₅ is the angle between the first side surface 512c and a perpendicular line drawn to an extension of the side of the first main surface 512a at the intersection of the first main surface 512a and the first side surface 512c of the multilayer body 512, and θ₆ is the angle between the second side surface 512d and a perpendicular line drawn to the extension of the side of the first main surface 512a at the intersection of the first main surface 512a and the second side surface 512d of the multilayer body 512.

It is preferable that about 5°≤θ₇≤about 50° and about 5°≤θ₈≤about 50°, for example, be satisfied, where θ₇ is the angle between the third side surface 512e and a perpendicular line drawn to the extension of the side of the first main surface 512a at the intersection of the first main surface 512a and the third side surface 512e of the multilayer body 512, and θ₈ is the angle between the fourth side surface 512f and a perpendicular line drawn to the extension of the side of the first main surface 512a at the intersection of the first main surface 512a and the fourth side surface 512f of the multilayer body 512.

The number of dielectric layers 514 to be laminated is not particularly limited, but is preferably 3 to 700, inclusive, in total, including the inner layer portion 515a, the first main surface-side outer layer portion 515b1, and the second main surface-side outer layer portion 515b2. Furthermore, the inner layer portion 515a preferably has a thickness of about 0.4 μm to about 2.0 μm, inclusive, for example. The first main surface-side outer layer portion 515b1 and the second main surface-side outer layer portion 515b2 each preferably have a thickness of about 2.0 μm to about 10.0 μm, inclusive, for example.

The dielectric layer 514 can be formed of a dielectric material, for example. The dielectric material can include a plurality of crystal grains including a perovskite compound with a basic structure of BaTiO₃, for example. As a specific material of the dielectric layer 514, dielectric ceramics composed mainly of CaTiO₃, SrTiO₃, CaZrO₃ or the like, besides BaTiO₃, can be used. Depending on the desired characteristics of the multilayer body, it is also possible to use a material including a smaller amount of subcomponent than the main component such as Mn compound, Fe compound, Cr compound, Co compound, or Ni compound.

As illustrated in FIGS. 18 to 21, the inner electrode layer 516 includes a plurality of first inner electrode layers 516a and a plurality of second inner electrode layers 516b. The first inner electrode layers 516a and the second inner electrode layers 516b are alternately laminated with the dielectric layer 514 interposed therebetween.

The first inner electrode layer 516a is on the surface of the dielectric layer 514. The first inner electrode layer 516a faces the first main surface 512a and the second main surface 512b, and has a first counter electrode portion 518a facing the second inner electrode layer 516b. The first inner electrode layers 516a are laminated in the direction connecting the first main surface 512a and the second main surface 512b.

The second inner electrode layer 516b is on the surface of a different dielectric layer 514 from the dielectric layer 514 on which the first inner electrode layer 516a is located. The second inner electrode layers 516b each include a second counter electrode portion 518b facing the first main surface 512a and the second main surface 512b, and are laminated in the direction connecting the first main surface 512a and the second main surface 512b.

As illustrated in FIGS. 18 to 21, the first inner electrode layer 516a is extended to the first side surface 512c and the third side surface 512e of the multilayer body 512 by a first extended electrode portion 520a, and is extended to the second side surface 512d and the fourth side surface 512f of the multilayer body 512 by a second extended electrode portion 520b. The width of the first extended electrode portion 520a extended to the first side surface 512c may be approximately equal to the width thereof extended to the third side surface 512e, and the width of the second extended electrode portion 520b extended to the second side surface 512d may be approximately equal to the width thereof extended to the fourth side surface 512f.

In other words, the first extended electrode portion 520a is extended to the third side surface 512e side of the multilayer body 512, and the second extended electrode portion 520b is extended to the fourth side surface 512f side of the multilayer body 512.

The second inner electrode layer 516b is extended to the first side surface 512c and the fourth side surface 512f of the multilayer body 512 by a third extended electrode portion 521a, and is extended to the second side surface 512d and the third side surface 512e of the multilayer body 512 by a fourth extended electrode portion 521b. The width of the third extended electrode portion 521a extended to the first side surface 512c may be approximately equal to the width thereof extended to the fourth side surface 512f, and the width of the fourth extended electrode portion 521b extended to the second side surface 512d may be approximately equal to the width thereof extended to the third side surface 512e.

In other words, the third extended electrode portion 521a is extended to the fourth side surface 512f side of the multilayer body 512, and the fourth extended electrode portion 521b is extended to the third side surface 512e side of the multilayer body 512.

Furthermore, when the multilayer ceramic capacitor 510 is viewed from the lamination direction, a line connecting the first extended electrode portion 520a and the second extended electrode portion 520b of the first inner electrode layer 516a preferably intersects with a line connecting the third extended electrode portion 521a and the fourth extended electrode portion 521b of the second inner electrode layer 516b.

Furthermore, on the first side surface 512c, the second side surface 512d, the third side surface 512e, and the fourth side surface 512f of the multilayer body 512, the first extended electrode portion 520a of the first inner electrode layer 516a and the fourth extended electrode portion 521b of the second inner electrode layer 516b are preferably extended to opposing positions, and the second extended electrode portion 520b of the first inner electrode layer 516a and the third extended electrode portion 521a of the second inner electrode layer 516b are preferably extended to opposing positions.

As illustrated in FIGS. 18 and 19, the multilayer body 512 includes side portions (W gaps) 522a of the multilayer body 512 formed between one end of the first counter electrode portion 518a in the width direction y and the first side surface 512c, and between the other end of the second counter electrode portion 518b in the width direction y and the second side surface 512d.

As illustrated in FIGS. 20 and 21, the multilayer body 512 also includes side portions (L gaps) 522b of the multilayer body 512 formed between one end of the first counter electrode portion 518a in the length direction z and the third side surface 512e, and between the other end of the second counter electrode portion 518b in the length direction z and the fourth side surface 512f.

The inner electrode layers 516 can be made of, but not limited to, an appropriate conductive material, such as metals such as Ni, Cu, Ag, Pd, and Au, or alloys including at least one of these metals, such as Ag—Pd alloy.

Sn included in the first inner electrode layer 516a and the second inner electrode layer 516b can alleviate the electric field concentration at the interface between the inner electrode layer 516 and the dielectric layer 514, leading to improved high-temperature load reliability. In this case, Sn can be sufficiently effective even if it is included in only one of the first inner electrode layer 516a and the second inner electrode layer 516b.

In this example embodiment, the first counter electrode portion 518a of the first inner electrode layer 516a and the second counter electrode portion 518b of the second inner electrode layer 516b face each other with the dielectric layer 514 interposed therebetween, thus generating an electrostatic capacitance and exhibiting capacitor characteristics.

In order to increase the capacitance of the capacitor, the area of the inner electrode layer 516 needs to be increased. Therefore, the inner electrode layer 516 preferably has a LW surface coverage of more than or equal to about 90%, for example. The LW surface coverage is defined as the percentage of the area inside the edge portion of the inner electrode layer 516 as viewed from the LW surface of the multilayer body 512 minus the area of any voids. The higher the LW surface coverage, the higher the capacitance of the capacitor. However, even with a lower LW surface coverage, the dielectric layers 514 are bonded with voids interposed therebetween, thus increasing the bonding strength between the layers to reduce or prevent interlayer peeling.

The inner layer portion 515a includes first projecting portions 540a on the first side surface 512c and the second side surface 512d. The inner layer portion 515a also includes second projecting portions 540b on the third side surface 512e and the fourth side surface 512f.

The first projecting portions 540a include the inner electrode layer 516 and the dielectric layer 514. More specifically, the first projecting portions 540a on the first side surface 512c and the second side surface 512d include the first inner electrode layer 516a and the dielectric layer 514 exposed from the first side surface 512c and the second side surface 512d and the second inner electrode layer 516b and the dielectric layer 514 exposed from the first side surface 512c and the second side surface 512d. This increases the surface area of the metal component and the dielectric component of the first projecting portions 540a, thus increasing at least the contact area between the metal component in the outer electrodes and the metal component of the multilayer body 512. As a result, the fixing strength between the multilayer body 512 and the outer electrodes 524 and 525 is improved.

In this case, at least two or more first projecting portions 540a are provided. Five or more first projecting portions 540a are more preferable to increase the contact area between the multilayer body 512 and the outer electrodes 524 and 525.

It is preferable that, in the width direction y, the angle T₁P₁P₂≥the angle T₁P₂P₁ be satisfied, where the vertex T₁ of the first projecting portion is the portion with the greatest thickness in the direction perpendicular to the end surface, P₁ is the end point of the first projecting portion 540a on the first main surface 512a side, and P₂ is the end point of the first projecting portion 540a on the second main surface 512b side. It is also preferable that the angle T₁P₁P₂ and the angle T₁P₂P₁ be about 15° to about 75°, inclusive, for example. This makes it possible to reduce the stress applied to the first projecting portion 540a.

The thickness of the first projecting portion 540a is the thickness in the direction perpendicular to the first side surface 512c. That is, the thickness t1 of the first projecting portion 540a is the shortest distance between the vertex T₁ of the first projecting portion 540a and the first side surface 512c of the multilayer body 512. The thickness t1 of the first projecting portion 540a is preferably about 0.3 μm to about 3.0 μm, inclusive, for example. If the thickness t1 of the first projecting portion 540a is less than about 0.3 μm, for example, the end surface is too smooth, making it difficult to sufficiently improve the fixing strength between the multilayer body 512 and the outer electrode 524.

The second projecting portions 540b include the inner electrode layer 516 and the dielectric layer 514. More specifically, the second projecting portions 540b on the third side surface 512e and the fourth side surface 512f include the first inner electrode layer 516a and the dielectric layer 514 exposed from the third side surface 512e and the fourth side surface 512f and the second inner electrode layer 516b and the dielectric layer 514 exposed from the third side surface 512e and the fourth side surface 512f. This increases the surface area of the metal component and the dielectric component of the second projecting portions 540b, thus increasing the contact area between the metal component in the outer electrodes and the metal component of the multilayer body 512 and between the dielectric component in the outer electrodes 524 and 525 and the dielectric component or the glass component in the outer electrodes. As a result, the fixing strength between the multilayer body 512 and the outer electrodes 524 and 525 is improved.

In this case, at least two or more second projecting portions 540b are provided. Five or more second projecting portions 540b are more preferable to increase the contact area between the multilayer body 512 and the outer electrodes 524 and 525.

It is preferable that, in the width direction y, the angle T₂P₃P₄≥the angle T₂P₄P₃ be satisfied, where the vertex T₂ of the second projecting portion is the portion having the greatest thickness in the direction perpendicular to the end surface, P₃ is the end point of the second projecting portion 540b on the first main surface 512a side, and P₄ is the end point of the second projecting portion 540b on the second main surface 512b side. It is also preferable that the angle T₂P₃P₄ and the angle T₂P₄P₃ be about 15° to about 75°, inclusive, for example. This makes it possible to reduce the stress applied to the second projecting portion 540b.

The thickness of the second projecting portion 540b is the thickness in the direction perpendicular to the third side surface 512e. That is, the thickness t2 of the second projecting portion 540b is the shortest distance between the vertex T₂ T₁ of the second projecting portion 540b and the third side surface 512e of the multilayer body 512. The thickness t2 of the second projecting portion 540b is preferably about 0.3 μm to about 3.0 μm, inclusive, for example. If the thickness t2 of the second projecting portion 540b is less than about 0.3 μm, for example, the end surface is too smooth, making it difficult to sufficiently improve the fixing strength between the multilayer body 512 and the outer electrodes 524 and 525.

The outer electrodes 524 and 525 are on the multilayer body 512, as illustrated in FIGS. 14 to 21.

The outer electrode 524 includes a thin film layer 526 and a plating layer 530 covering the thin film layer 526.

The outer electrode 525 includes a thin film layer 527 and a plating layer 531 covering the thin film layer 527.

The outer electrode 524 includes a first outer electrode 524a and a second outer electrode 524b.

The first outer electrode 524a covers the first extended electrode portion 520a on the first side surface 512c and the third side surface 512e, and to cover a portion of the first main surface 512a. The first outer electrode 524a is electrically connected to the first extended electrode portion 520a of the first inner electrode layer 516a.

The second outer electrode 524b covers the second extended electrode portion 520b on the second side surface 512d and the fourth side surface 512f, and to cover a portion of the first main surface 512a. The second outer electrode 524b is electrically connected to the second extended electrode portion 520b of the first inner electrode layer 516a.

The outer electrode 525 includes a third outer electrode 525a and a fourth outer electrode 525b.

The third outer electrode 525a covers the third extended electrode portion 521a on the first side surface 512c and the fourth side surface 512f, and to cover a portion of the first main surface 512a. The third outer electrode 525a is electrically connected to the third extended electrode portion 521a of the second inner electrode layer 516b.

The fourth outer electrode 525b covers the fourth extended electrode portion 521b on the second side surface 512d and the third side surface 512e, and to cover a portion of the first main surface 512a. The fourth outer electrode 525b is electrically connected to the fourth extended electrode portion 521b of the second inner electrode layer 516b.

Within the multilayer body 512, the first counter electrode portion 518a of the first inner electrode layer 516a and the second counter electrode portion 518b of the second inner electrode layer 516b face each other with the dielectric layer 514 interposed therebetween, thus generating an electrostatic capacitance. The electrostatic capacitance is thus obtained between the first and second outer electrodes 524a and 524b, to which the first inner electrode layer 516a is connected, and the third and fourth outer electrodes 525a and 525b, to which the second inner electrode layer 516b is connected, thus exhibiting the capacitor characteristics.

The thin film layer 526 includes a first thin film layer 526a and a second thin film layer 526b.

The thin film layer 527 includes a third thin film layer 527a and a fourth thin film layer 527b.

The first thin film layer 526a covers a portion of the first main surface 512a of the multilayer body 512 on the first side surface 512c side and the third side surface 512e side, but does not cover the first side surface 512c and the third side surface 512e of the multilayer body 512.

The second thin film layer 526b covers a portion of the first main surface 512a of the multilayer body 512 on the second side surface 512d side and the fourth side surface 512f side, but does not cover the second side surface 512d and the fourth side surface 512f.

The third thin film layer 527a covers a portion of the first main surface 512a of the multilayer body 512 on the first side surface 512c side and the fourth side surface 512f side, but does not cover the first side surface 512c and the fourth side surface 512f.

The fourth thin film layer 527b covers a portion of the first main surface 512a of the multilayer body 512 on the third side surface 512e side and the second side surface 512d side, but does not cover the third side surface 512e and the second side surface 512d.

The first thin film layer 526a to the fourth thin film layer 527b are preferably formed by deposition of metal particles using a method such as sputtering or vapor deposition. Accordingly, the thickness of the first thin film layer 526a to the fourth thin film layer 527b in the direction connecting the first main surface 512a and the second main surface 512b of the multilayer body 512 can be smaller than or equal to about 1 μm, for example, allowing the dimension in the height direction x of the multilayer ceramic capacitor 510 to be sufficiently small for height reduction of the multilayer ceramic capacitor 510.

The dimension in the height direction x of the first thin film layer 526a to the fourth thin film layer 527b can be measured as follows. Specifically, in a case of forming the thin film layers by depositing metal particles, a fluorescent X-ray apparatus can be used to obtain the thickness converted from the concentration of a specified element using the calibration curve method for the relevant metal species. Alternatively, an FIB cross-section of the component can be observed with a scanning microscope to measure the thickness from an actual observation image.

In a case of forming the first thin film layer 526a to the fourth thin film layer 527b by a thin film formation method, these thin film layers can be including metals such as Cu, Cr, Au, Pt, Ag, Sn, Ti, or Ni.

The first thin film layer 526a to the fourth thin film layer 527b can be formed taking into consideration their respective functions. For example, in consideration of adhesion with the multilayer body 512, the first thin film layer 526a to the fourth thin film layer 527b can be including NiCr or the like. For example, in consideration of adhesion with the multilayer body 512, NiCr or NiCu is preferably used as the main component. Alternatively, the first thin film layer 526a to the fourth thin film layer 527b may be including a plurality of layers, or may have a two-layer structure of NiCr and NiCu.

The thin film layers 526 and 527 may be formed by screen printing, CVD, ALD, or the like, and contain a dielectric material and a metal component. These methods can further improve the fixing strength between the multilayer body and the outer electrodes by fixing the thin film layer 526 and 527 and the ceramic of the multilayer body 512. In this case, the thin film layers 526 and 527 may have a discontinuous shape. The term “discontinuous” means that the thin film layers are formed discontinuously as viewed from a direction perpendicular to the longitudinal direction.

For example, in a case of forming the thin film layers 526 and 527 from a ceramic-including material, one method is to polish the cross-section and then take a sectional image using a digital microscope (Keyence Corporation: VHX-5000) to calculate the thickness from the sectional image. Another method is to measure the thickness or other parameters from an FIB sectional image of the component actually observed with a scanning microscope.

In a case where the first thin film layer 526a to the fourth thin film layer 527b each include the same main component as the dielectric layer 514, the adhesion can be further improved by simultaneously firing the multilayer body 512 with the first to fourth thin film layers. In this case, the metal component is preferably Ni, Cu, or the like, but can be changed as appropriate depending on the metal component of the inner electrode layer 516.

The plating layer 530 includes a first plating layer 530a and a second plating layer 530b.

The first plating layer 530a covers the first thin film layer 526a and the first and third side surfaces 512c and 512e of the multilayer body 512.

The second plating layer 530b covers the second thin film layer 526b and the second and fourth side surfaces 512d and 512f of the multilayer body 512.

The plating layer 531 includes a third plating layer 531a and a fourth plating layer 531b.

The third plating layer 531a covers the third thin film layer 527a and the first and fourth side surfaces 512c and 512f of the multilayer body 512.

The fourth plating layer 531b covers the fourth thin film layer 527b and the second and third side surfaces 512d and 512e of the multilayer body 512.

The plating layers 530 and 531 are each include a plurality of layers. Specifically, the plating layer 530 includes an upper plating layer 534 and a surface plating layer 536. The plating layer 531 includes an upper plating layer 535 and a surface plating layer 537.

The upper plating layer 534 includes a first upper plating layer 534a included in the first plating layer 530a and a second upper plating layer 534b included in the second plating layer 530b. The surface plating layer 536 includes a first surface plating layer 536a included in the first plating layer 530a and a second surface plating layer 536b included in the second plating layer 530b.

The upper plating layer 535 includes a third upper plating layer 535a included in the third plating layer 531a and a fourth upper plating layer 535b included in the fourth plating layer 531b. The surface plating layer 537 includes a third surface plating layer 537a included in the third plating layer 531a and a fourth surface plating layer 537b included in the fourth plating layer 531b.

The first upper plating layer 534a of the upper plating layer 534 covers the first thin film layer 526a.

The second upper plating layer 534b of the upper plating layer 534 covers the second thin film layer 526b.

The third upper plating layer 535a of the upper plating layer 535 covers the third thin film layer 527a.

The fourth upper plating layer 535b of the upper plating layer 535 covers the fourth thin film layer 527b.

The upper plating layers 534 and 535 are preferably Ni plating to reduce solder corrosion.

The first surface plating layer 536a of the surface plating layer 536 covers the first upper plating layer 534a of the upper plating layer 534.

The second surface plating layer 536b of the surface plating layer 536 covers the second upper plating layer 534b of the upper plating layer 534.

The third surface plating layer 537a of the surface plating layer 537 covers the third upper plating layer 535a of the upper plating layer 535.

The fourth surface plating layer 537b of the surface plating layer 537 covers the fourth upper plating layer 535b of the upper plating layer 535.

The surface plating layers 536 and 537 are preferably Sn plating with good bonding strength with solder used for mounting of the multilayer ceramic capacitor 510. The surface plating layers 536 and 537 may also be Cu plating. In this case, the bonding strength with vias formed when the multilayer ceramic capacitor 510 is embedded in a mounting substrate is improved.

The plating layer 530 may include only the surface plating layer 536. In this case, the first surface plating layer 536a of the surface plating layer 536 covers the first thin film layer 526a, and the second surface plating layer 536b of the surface plating layer 536 covers the second thin film layer 526b. Similarly, the plating layer 531 may include only the surface plating layer 537. In this case, the third surface plating layer 537a of the surface plating layer 537 covers the third thin film layer 527a, and the fourth surface plating layer 537b of the surface plating layer 537 covers the fourth thin film layer 527b.

The metal content per unit volume of the plating layers 530 and 531 is preferably more than or equal to about 99 volume %, for example.

The thickness per layer of the plating layers 530 and 531 is preferably about 1.0 μm to about 10.0 μm, inclusive, for example.

It is assumed that the dimension in the length direction z of the multilayer ceramic capacitor 510, including the multilayer body 512 and the outer electrodes 524 and 525, is the L dimension, the dimension in the height direction x of the multilayer ceramic capacitor 510, including the multilayer body 512 and the outer electrodes 524 and 525, is the T dimension, and the dimension in the width direction y of the multilayer ceramic capacitor 510, including the multilayer body 512 and the outer electrodes 524 and 525, is the W dimension.

It is preferable that the dimensions of the multilayer ceramic capacitor 510 be such that the L dimension in the length direction z is about 0.1 mm to about 1.6 mm, inclusive, the T dimension in the height direction x is about 10 μm to about 100 μm, inclusive, and the W dimension in the width direction y is about 0.1 mm to about 1.6 mm, inclusive. The dimensions of the multilayer ceramic capacitor 510 preferably satisfy about 7/10≤L/W≤about 10/7, for example. This causes the multilayer body 512 to have a substantially tetragonal shape, thus improving the degree of freedom of mounting.

In this example embodiment, the effects of the present invention can be effectively achieved when the T dimension in the height direction x of the multilayer ceramic capacitor 510 is less than or equal to about 100 μm, and are even more effective when the T dimension in the height direction x of the multilayer ceramic capacitor 510 is less than or equal to about 55 μm, or less than or equal to about 50 μm, for example.

In the multilayer ceramic capacitor 510 illustrated in FIG. 14, the outer electrode 524 includes the first thin film layer 526a on the first main surface 512a and the second main surface 512b of the multilayer body 512, and includes the second thin film layer 526b on the first main surface 512a and the second main surface 512b of the multilayer body 512.

Moreover, in the multilayer ceramic capacitor 510, the outer electrode 525 includes the third thin film layer 527a on the first main surface 512a and the second main surface 512b of the multilayer body 512, and includes the fourth thin film layer 527b on the first main surface 512a and the second main surface 512b of the multilayer body 512.

Furthermore, in the multilayer ceramic capacitor 510, the electrical connection between the outer electrode 524 and the inner electrode layer 516 is made not using the first thin film layer 526a to the fourth thin film layer 527b, but using the plating layers 530 and 531 on the first side surface 512c to the fourth side surface 512f.

The shape of the outer electrodes 524 and 525 may follow the outer shape of the multilayer body 512. In other words, when a first projecting portion 540a and a second projecting portion 540b are provided, the outer electrodes 524 and 525 may also have an uneven shape, as with the shapes of the first side surface 512c, the second side surface 512d, the third side surface 512e, and the fourth side surface 512f of the multilayer body 512.

The multilayer ceramic capacitor 510 according to the second example embodiment illustrated in FIG. 14 achieves the same effects as the multilayer ceramic capacitor 10.

The multilayer ceramic capacitor 510 according to the second example embodiment of the present invention may also be combined with all or a portion of the first to fourth modifications of the multilayer ceramic capacitor 10 according to the first example embodiment, as well as other modifications illustrated in the respective drawings.

A non-limiting example of a method for manufacturing a multilayer ceramic capacitor as an example of the multilayer ceramic capacitor according to the second example embodiment will be described below.

First, a dielectric sheet and a conductive paste for inner electrodes are prepared. The dielectric sheet and the conductive paste for inner electrode layers contain a binder (for example, a known organic binder) and a solvent (for example, a known organic solvent).

Next, the conductive paste for inner electrodes is applied in a predetermined pattern onto the dielectric sheet by screen printing, gravure printing or the like, for example, to form an inner electrode pattern. Specifically, a conductive paste layer is formed by applying a paste made of a conductive material onto the dielectric sheet using a method such as the printing method described above. The conductive paste is prepared, for example, by adding an organic binder and organic solvent to a metal powder. As for the dielectric sheet, a dielectric sheet for outer layers without any inner electrode pattern printed thereon is also prepared.

The dielectric sheet in which the inner electrode pattern corresponding to the first inner electrode layer 516a is formed, and the dielectric sheet in which the inner electrode pattern corresponding to the second inner electrode layer 516b is formed are thus prepared.

More specifically, the inner electrode layers of the present invention can be printed by separately preparing a screen plate for printing the first inner electrode layer 516a and a screen plate for printing the second inner electrode layer 516b, and using a printer capable of printing with the two types of screen plates separately.

A multilayer sheet is prepared using these dielectric sheets having the inner electrode patterns formed thereon. Specifically, a predetermined number of dielectric sheets for outer layers without any inner electrode pattern formed thereon are laminated to form a portion to be the first main surface-side outer layer portion 515b1 on the first main surface 512a side. Then, the dielectric sheet with the inner electrode pattern formed thereon, corresponding to the first inner electrode layer 516a, and the dielectric sheet with the inner electrode pattern formed thereon, corresponding to the second inner electrode layer 516b are alternately laminated thereon to form a portion to be the inner layer portion 515a. Finally, a predetermined number of dielectric sheets for outer layers without any inner electrode pattern formed thereon are further laminated thereon to form a portion to be the second main surface-side outer layer portion 515b2. Accordingly, the multilayer sheet is formed.

Furthermore, the multilayer sheet is pressed in the lamination direction by an isostatic press or the like to form a multilayer block.

Next, the multilayer block is cut to a specified size to cut out multilayer chips. Thereafter, wet barreling may be performed to round the corners and ridge portions of the multilayer chip.

The multilayer chip is formed into a tapered shape. Upon cutting the multilayer block into chips, a dicer cut is made using a tapered blade to form an angled end surface shape. The taper angle is between about 10° and about 80°, inclusive, for example, with a non-tapered blade having the taper angle of 0°, for example. Since the taper angle of the blade taper does not necessarily correspond to the angle of the end surface of the cut chip, the taper angle is finely adjusted to the desired angle.

Accordingly, all side surfaces are inclined so as to splay out from the first main surface side toward the second main surface side. As a result, the inner electrode pattern exposed from all side surfaces can be confirmed as seen from the first main surface side.

Next, the multilayer chip is fired to produce the multilayer body 512. The firing temperature depends on the ceramic and the material of the inner electrode, but is preferably between about 900° C. and about 1400° C., inclusive, for example.

Next, the fired multilayer chips are aligned on an adhesive tape with the first main surface side facing upward. For example, if the first main surface side faces upward, the inner electrode layer 516 can be confirmed from all side surfaces, allowing for appearance selection and alignment.

The chips are then sandblasted with an abrasive and polished at an angle perpendicular to the first main surface. During this process, the outer layer portions near the first main surface side on all side surfaces are easily scraped. On the other hand, the outer layer portions near the second main surface side on all side surfaces are not easily scraped because the inner electrode layers 516 exposed from all side surfaces form an umbrella. Furthermore, cutting debris from the sandblasting process is easily accumulated to reduce or prevent the scraping. Since the likelihood of scraping differs between the first main surface-side outer layer portion and the second main surface-side outer layer portion, the projecting portions 540 and 541 can be formed on all side surfaces. Examples of the abrasive to be used include alumina oxide abrasive, zirconia alumina abrasive, silicon carbide abrasive, and the like.

After sandblasting, any cutting debris adhering to the multilayer chips is removed. Such cutting debris can be removed, for example, by blowing air onto the chips.

Then, the multilayer chips with the projecting portions formed thereon are removed from the adhesive tape. In this event, with the use of a foam release sheet as the adhesive tape, for example, a plurality of multilayer chips can be removed all at once by applying heat.

Thereafter, the multilayer body 512 with the first projecting portion 540a and the second projecting portion 540b formed thereon is aligned on a workbench, and thin film layers 526 and 527 are formed on the first main surface 512a by sputtering.

Next, upper plating layers 534 and 535 and surface plating layers 536 and 537 are sequentially formed.

In other words, the first upper plating layer 534a of the upper plating layer 534 covers the first thin film layer 526a on a portion of the first main surface 512a of the multilayer body 512, and the first surface plating layer 536a of the surface plating layer 536 covers the first upper plating layer 534a.

The second upper plating layer 534b of the upper plating layer 534 covers the second thin film layer 526b on a portion of the first main surface 512a of the multilayer body 512, and the second surface plating layer 536b of the surface plating layer 536 covers the second upper plating layer 534b.

The third upper plating layer 535a of the upper plating layer 535 covers the third thin film layer 527a on a portion of the first main surface 512a of the multilayer body 512, and the third surface plating layer 537a of the surface plating layer 537 covers the third upper plating layer 535a.

The fourth upper plating layer 535b of the upper plating layer 535 covers the fourth thin film layer 527b on a portion of the first main surface 512a of the multilayer body 512, and the fourth surface plating layer 537b of the surface plating layer 537 covers the fourth upper plating layer 535b.

Specifically, the upper plating layers 534 and 535 are Ni plating, and the surface plating layers 536 and 537 are Sn plating, which are formed by electrolytic plating or electroless plating.

The multilayer ceramic capacitor 510 according to the second example embodiment illustrated in FIG. 14 is thus manufactured.

The method for manufacturing a multilayer ceramic capacitor according to this example embodiment allows for a reduction in the thickness as the T dimension in the height direction x of the outer electrodes 524 and 525 formed on the first and second main surfaces 512a and 512b. This makes it possible to provide a multilayer ceramic capacitor with reduced height without impairing mountability upon mounting.

Next, an example of a multilayer ceramic capacitor 610 according to a third example embodiment of the present invention will be described.

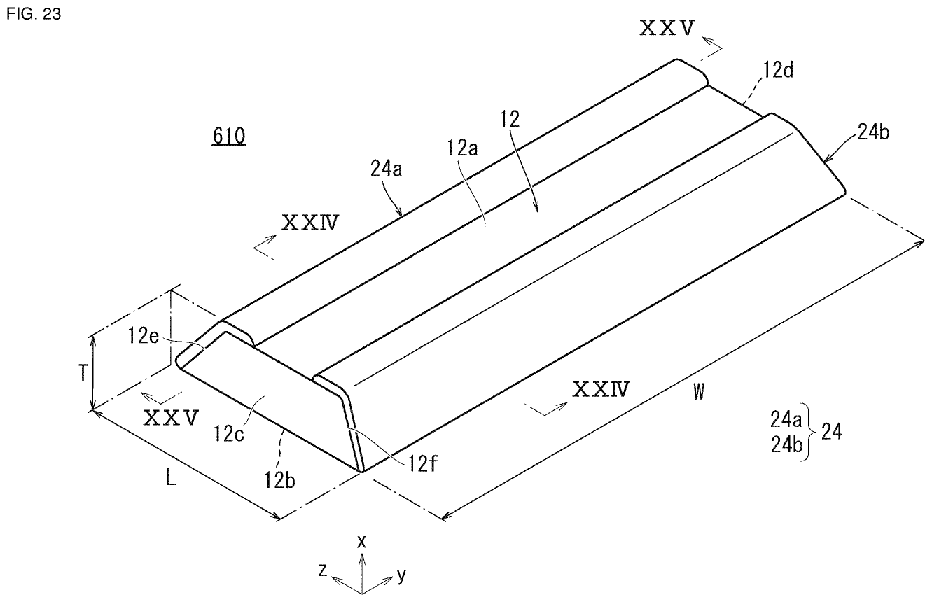

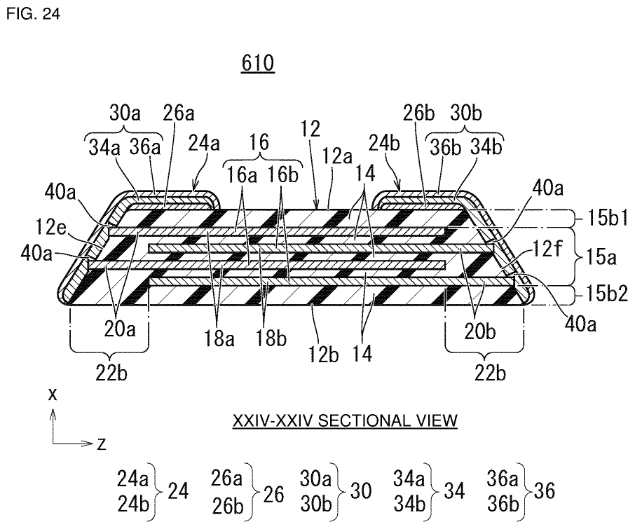

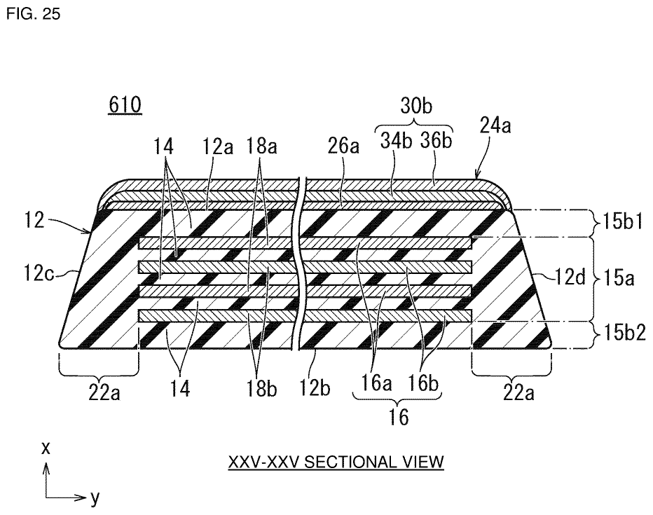

FIG. 23 is an external perspective view illustrating an example of the multilayer ceramic capacitor according to the third example embodiment of the present invention. FIG. 24 is a schematic sectional view taken along line XXIV-XXIV in FIG. 23, illustrating a structure of an example of the multilayer ceramic capacitor according to the third example embodiment of the present invention. FIG. 25 is a schematic sectional view taken along line XXV-XXV in FIG. 23, illustrating a structure of an example of the multilayer ceramic capacitor according to the third example embodiment of the present invention.

The multilayer ceramic capacitor 610 according to the third example embodiment of the present invention has a multilayer body 12 and an outer electrode 24 having the same configurations as those of the multilayer ceramic capacitor 10 according to the first example embodiment. However, compared to the multilayer ceramic capacitor 10 according to the first example embodiment, the magnitude relationship between the L dimension and the W dimension of the multilayer ceramic capacitor 610 is reversed, with the W dimension being larger than the L dimension.

The multilayer ceramic capacitor 610 illustrated in FIG. 23 having the above configuration achieves the same effects as the multilayer ceramic capacitor 10 according to the first example embodiment.

In the multilayer ceramic capacitor according to the third example embodiment of the present invention, the outer electrode 24 of the multilayer ceramic capacitor 610 is preferably all or a portion of the first to fourth modifications similar to the outer electrodes 24 of the first to fourth modifications of the multilayer ceramic capacitor 10 according to the first example embodiment, or a combination of all or part thereof.

A non-limiting example of a method for manufacturing a multilayer ceramic capacitor as an example of a multilayer ceramic capacitor according to the third example embodiment will be described.

The method for manufacturing a multilayer ceramic capacitor according to the third example embodiment is the same as the method for manufacturing a multilayer ceramic capacitor according to the first example embodiment. However, the L dimension and the W dimension are interchanged compared to the multilayer ceramic capacitor 10 according to the first example embodiment.

The multilayer ceramic capacitor 610 according to the third example embodiment illustrated in FIG. 23 can thus be manufactured.

The method for manufacturing a multilayer ceramic capacitor according to this example embodiment described above can reduce the thickness of the outer electrode 24 formed on the first main surface 12a, that is, the T dimension in the height direction x. This makes it possible to provide a multilayer ceramic capacitor with further reduced height.

While the example embodiments of the present invention have been disclosed above, the present invention is not limited thereto.

Specifically, various changes can be made to the example embodiments and modifications described above in terms of mechanism, shape, material, quantity, position, arrangement, and the like, without departing from the scope of the technical idea and purpose of the present invention, and such changes are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers, a plurality of inner electrode layers, a first main surface and a second main surface facing each other in a lamination direction, a first side surface and a second side surface facing each other in a width direction orthogonal to the lamination direction, and a first end surface and a second end surface facing each other in a length direction orthogonal to the lamination direction and the width direction;
a first outer electrode on the first main surface and the first end surface of the multilayer body; and
a second outer electrode on the first main surface and the second end surface of the multilayer body; wherein the inner electrode layers are exposed from the first end surface and the second end surface;
the first end surface, from which the inner electrode layers are exposed, are inclined so as to splay out from the first main surface toward the second main surface; and
first projecting portions including the dielectric layers and the inner electrode layers are provided on the first end surface.

2. The multilayer ceramic capacitor according to claim 1, further comprising:
a third outer electrode on the first side surface of the multilayer body; and
a fourth outer electrode on the second side surface of the multilayer body; wherein the inner electrode layers are exposed from the first side surface and the second side surface;
the first side surface, from which the inner electrode layers are exposed, are inclined so as to splay out from the first main surface toward the second main surface;
second projecting portions including the dielectric layers and the inner electrode layers are provided on the first side surface; and
about 7/10≤L/W≤about 10/7 is satisfied, where L is a dimension in the length direction and W is a dimension in the width direction.

3. The multilayer ceramic capacitor according to claim 1, wherein at least two or more of the first projecting portions are provided on each of the first end surface.

4. The multilayer ceramic capacitor according to claim 2, wherein at least two or more of the second projecting portions are provided on each of the first side surface.

5. The multilayer ceramic capacitor according to claim 1, wherein in the width direction, in any one of the first projecting portions:
an angle T₁P₁P₂≥an angle T₁P₂P₁ is satisfied; where a vertex T₁ of the first projecting portion is a portion with a greatest thickness in a direction perpendicular to the end surface;
P₁ is an end point of the first projecting portion on the first main surface side; and
P₂ is an end point of the first projecting portion on the second main surface side.

6. The multilayer ceramic capacitor according to claim 2, wherein in the length direction, in any one of the second projecting portions:
an angle T₂P₃P₄≥an angle T₂P₄P₃ is satisfied; where a vertex T₂ of the second projecting portion is a portion with a greatest thickness in a direction perpendicular to the side surface;
P₃ is an end point of the second projecting portion on the first main surface side; and
P₄ is an end point of the second projecting portion on the second main surface side.

7. The multilayer ceramic capacitor according to claim 5, wherein each of the angle T₁P₁P₂ and the angle T₁P₂P₁ is about 15° to about 75°, inclusive.

8. The multilayer ceramic capacitor according to claim 6, wherein each of the angle T₂P₃P₄ and the angle T₂P₄P₃ is about 15° to about 75°, inclusive.

9. The multilayer ceramic capacitor according to claim 1, wherein a thickness of any one of the first projecting portions is about 0.3 μm to about 3.0 μm, inclusive, in a direction perpendicular to the first end surface.

10. The multilayer ceramic capacitor according to claim 2, wherein a thickness of any one of the second projecting portions is about 0.3 μm to about 3.0 μm, inclusive, in a direction perpendicular to the first side surface.

11. The multilayer ceramic capacitor according to claim 1, wherein an area of the first main surface is less than an area of the second main surface.

12. The multilayer ceramic capacitor according to claim 2, wherein an area of the first main surface is less than an area of the second main surface.

13. The multilayer ceramic capacitor according to claim 1, wherein about 5°≤θ₁≤about 50°, where θ₁ is an angle between the first end surface and a perpendicular line drawn to an extension of a side of the first main surface at an intersection of the first main surface and the first end surface of the multilayer body.

14. The multilayer ceramic capacitor according to claim 1, wherein about 5°≤θ₃≤about 50°, where θ₃ is an angle between the first side surface and a perpendicular line drawn to an extension of a side of the first main surface at an intersection of the first main surface and the first side surface of the multilayer body.

15. The multilayer ceramic capacitor according to claim 4, wherein in the length direction, in any one of the second projecting portions:
an angle T₂P₃P₄≥an angle T₂P₄P₃ is satisfied; where
a vertex T₂ of the second projecting portion is a portion with a greatest thickness in a direction perpendicular to the side surface;
P₃ is an end point of the second projecting portion on the first main surface side; and
P₄ is an end point of the second projecting portion on the second main surface side.

16. The multilayer ceramic capacitor according to claim 4, wherein a thickness of any one of the second projecting portions is about 0.3 μm to about 3.0 μm, inclusive, in a direction perpendicular to the first side surface.

17. The multilayer ceramic capacitor according to claim 4, wherein an area of the first main surface is less than an area of the second main surface.

18. The multilayer ceramic capacitor according to claim 12, wherein in the length direction, in any one of the second projecting portions:
an angle T₂P₃P₄≥an angle T₂P₄P₃ is satisfied; where
a vertex T₂ of the second projecting portion is a portion with a greatest thickness in a direction perpendicular to the side surface;
P₃ is an end point of the second projecting portion on the first main surface side; and
P₄ is an end point of the second projecting portion on the second main surface side.

19. The multilayer ceramic capacitor according to claim 12, wherein a thickness of any one of the second projecting portions is about 0.3 μm to about 3.0 μm, inclusive, in a direction perpendicular to the first side surface.

20. The multilayer ceramic capacitor according to claim 1, wherein a width dimension of the multilayer ceramic capacitor is larger than a length dimension of the multilayer ceramic capacitor.
